(19) United States
(12) Patent Application Publication
(10) Pub. No.: US 2014/0337089 A1
(43) Pub. Date: Nov. 13, 2014

(54) SYSTEMS AND METHODS TO CONNECT INFORMATION

(71) Applicant: Visa International Service Association, San Francisco, CA (US)

(72) Inventor: Silvio Orlando Renaud Tavares, Foster City, CA (US)

(21) Appl. No.: 13/889,966

(22) Filed: May 8, 2013

(51) Int. Cl. G06Q 30/02

(52) U.S. Cl. CPC G06Q 30/0201
USPC 705/7.29

(57) ABSTRACT

A system and method to link online and offline user data via transaction data. Online and/or offline user data can be tracked via various anonymous tracking methods that do not require the users to explicitly identify themselves. Through linking online payment transactions with online user data and linking offline payment transactions with offline user data, the system and method links the online user data and the offline user data that are linked respectively to online and offline payment transactions made in the same payment account. Combining the online user data and offline user data in connection with online and offline payment transactions provides comprehensive information about the user, which can be used to provide improved services to the user.

### CROSS-REFERENCE TO RELATED APPLICATIONS

The present application relates to U.S. patent application Ser. No. 12/849,798, filed Aug. 3, 2010, and U.S. patent application Ser. No. 13/277,165, filed Oct. 19, 2011, both entitled “Systems and Methods to Match Identifiers,” the disclosures of which applications are hereby incorporated herein by reference.

### FIELD OF THE TECHNOLOGY

At least some embodiments of the present disclosure relate to user tracking, the processing of transaction data, such as records of payments made via credit cards, debit cards, prepaid cards, etc., and/or providing information based on the processing of the transaction data.

### BACKGROUND

Millions of transactions occur daily through the use of payment cards, such as credit cards, debit cards, prepaid cards, etc. Corresponding records of the transactions are recorded in databases for settlement and financial record keeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008 and entitled “Techniques for Targeted Offers.”

U.S. Pat. App. Pub. No. 2009/0216579, published on Aug. 27, 2009 and entitled “Tracking Online Advertising using Payment Services,” discloses a system in which a payment service identifies the activity of a user using a payment card as corresponding with an offer associated with an online advertisement presented to the user.

U.S. Pat. No. 6,298,330, issued on Oct. 2, 2001 and entitled “Communicating with a Computer Based on the Offline Purchase History of a Particular Consumer,” and U.S. Pat. No. 6,055,573, issued Apr. 25, 2000 and entitled “Communicating with a Computer based on an Updated Purchase Behavior Classification of a Particular Consumer”, discloses systems in which a targeted advertisement is delivered to a computer in response to receiving an identifier, such as cookie, corresponding to the computer.

U.S. Pat. No. 7,035,855, issued on Apr. 25, 2006 and entitled “Process and System for Integrating Information from Disparate Databases for Purposes of Predicting Consumer Behavior,” discloses a system in which consumer transactional information is used for predicting consumer behavior.

U.S. Pat. No. 6,505,168, issued on Jan. 7, 2003 and entitled “System and Method for Gathering and Standardizing Customer Purchase Information for Target Marketing,” discloses a system in which categories and sub-categories are used to organize purchasing information by credit cards, debit cards, checks and the like. The customer purchase information is used to generate customer preference information for making targeted offers.

U.S. Pat. No. 7,444,658, issued on Oct. 28, 2008 and entitled “Method and System to Perform Content Targeting,” discloses a system in which advertisements are selected to be sent to users based on a user classification performed using credit card purchasing data.

U.S. Pat. App. Pub. No. 2005/0055275, published on Mar. 10, 2005 and entitled “System and Method for Analyzing Marketing Efforts,” discloses a system that evaluates the cause and effect of advertising and marketing programs using card transaction data.

U.S. Pat. App. Pub. No. 2008/0217397, published on Sep. 11, 2008 and entitled “Real-Time Awards Determinations,” discloses a system for facilitating transactions with real-time awards determinations for a cardholder, in which the award may be provided to the cardholder as a credit on the cardholder's statement.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 illustrates a system to provide services based on transaction data according to one embodiment.

FIG. 2 illustrates the generation of an aggregated spending profile according to one embodiment.

FIG. 3 shows a method to generate an aggregated spending profile according to one embodiment.

FIG. 4 shows a system to provide information based on transaction data according to one embodiment.

FIG. 5 illustrates a transaction terminal according to one embodiment.

FIG. 6 illustrates an account identifying device according to one embodiment.

FIG. 7 illustrates a data processing system according to one embodiment.

FIG. 8 shows the structure of account data for providing loyalty programs according to one embodiment.

FIG. 9 shows a system to obtain purchase details according to one embodiment.

FIG. 10 shows a system to target advertisements according to one embodiment.

FIGS. 11-12 illustrate systems to map user identifiers to account identifiers according to some embodiments.

FIG. 13 shows a method to map user identifiers to account identifiers according to some embodiments.

FIG. 14 shows a system to connect information via transaction data according to one embodiment.

FIG. 15 shows a method to connect information via transaction data according to one embodiment.

### DETAILED DESCRIPTION

### Introduction

A computing system can be configured to link online and offline user data via transaction data. Online and/or offline user data can be tracked via various anonymous tracking methods that do not require the users to explicitly identify themselves. Through linking online payment transactions with online user data and linking offline payment transactions with offline user data, the system and method link the online and offline user data that are linked respectively to online and offline payment transactions made in the same payment account. Combining the online user data and offline user data in connection with online and offline payment transactions provides comprehensive information about the user, which can be used to provide improved services to the user. Some details and examples of linking user data via transaction data are provided in the section entitled “CONNECT INFORMATION.”

The transaction data, such as records of transactions made via credit accounts, debit accounts, prepaid accounts, bank accounts, stored value accounts and the like, can be processed to optionally provide information for various services, such as reporting, benchmarking, advertising, content or offer selection, customization, personalization, prioritization, etc. In one embodiment of improving privacy protections, users are required to enroll in a service program and provide consent to allow the system to use related transaction data and/or other data for the related services, and the system is configured to provide the services while protecting the privacy of the users in accordance with the enrollment agreement and user consent.

For example, based on the transaction data and/or the user data linked via the transaction data, an advertising network can present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. The transaction handler may be further automated to process the advertisement fees charged to the advertisers, using the accounts of the advertisers, in response to the advertising activities. Some of the services are discussed in the section entitled “TRANSACTION DATA BASED SERVICES.”

### Connect Information

A system and method can be configured to connect user information through the use of data correlation operations to link online/offline user identifiers with online/offline transactions and through the use of payment account information that links online transactions with offline transactions. Thus, the system and method can connect various pieces of otherwise unconnected information to provide a comprehensive view of the preferences and provide enhanced services to the user based on the comprehensively connected information.

For example, online user activities can be tracked via browser cookie based methods or other methods. Online user data such as uniform resource locators (URLs)/webpages visited, online behaviors (e.g., typing speed/pattern), mobile locations determined by global positioning system (GPS) receivers, biometrics used in online systems for authentication, etc., can be collected and associated with online identifiers, such as cookie ID, internet protocol (IP) address, media access control (MAC) address, mobile phone number, mobile station international subscriber directory number (MSISDN), or other device identifiers. Through data correlation operations, the online user data can be linked to online transactions for further association with offline transactions in the same account and offline user data linked to the respective offline transaction.

For example, the transaction data recording transactions made offline (e.g., at retail locations of merchants via a card-present type of payment transactions) can be linked to offline user data such as voice, noise, image, receipt, warrantee, time, location, etc., captured at point of sale (POS) terminals during the offline payment transactions.

Further, the user data connected in the system may further include data tracked using methods that require the users to present an identifier, such as a member ID, a loyalty account, etc.

For example, when the online user data is linked to the transaction data, the transaction data can be used to augment the online information to create an augmented tracking profile that includes the online information as well as offline information.

For example, a service of mapping the offline information can be provided in an anonymous way to assist advertisers so that the provided transaction-based information is not identifiable to a particular card or person. When appending transaction information, identifiers that may reveal the identity of the user, such as the primary account number or personal account number, or other identifiers of the user, are stripped off. Some of the transaction information may be annonymized (e.g., replacing transaction amount with a range, replacing a merchant with a merchant category code).

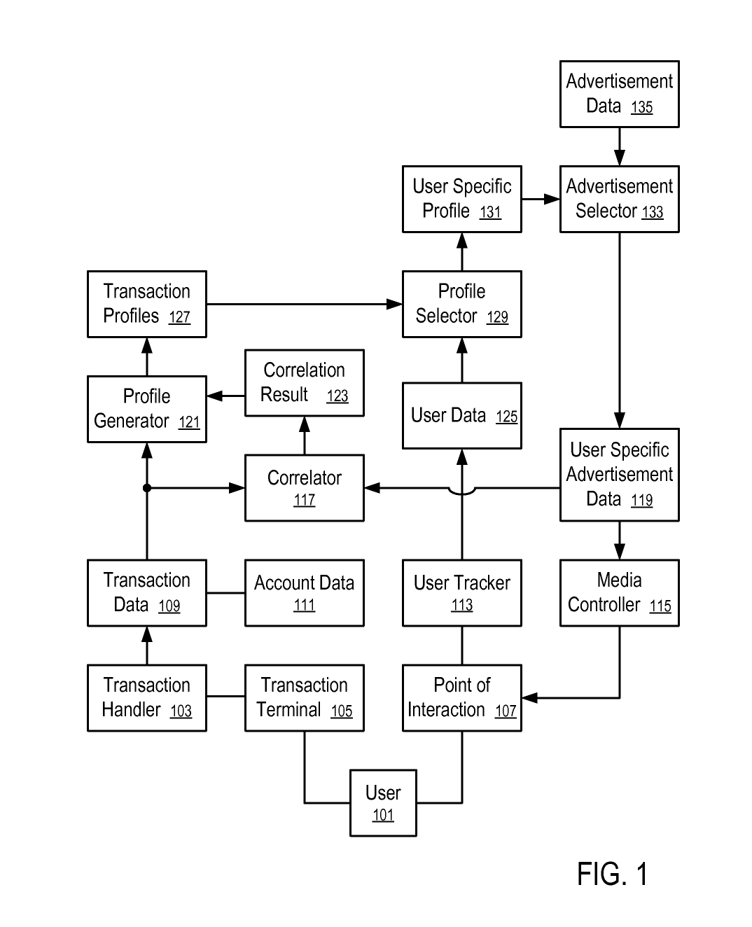

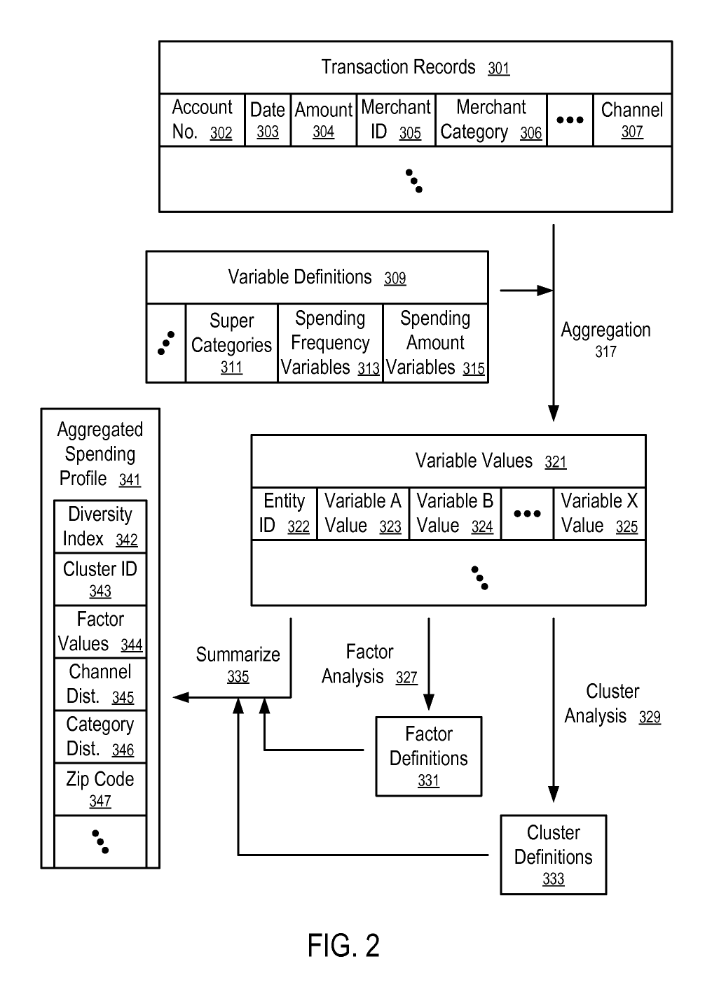

For example, a transaction profile summarizing and annonymizing the transaction data can be provided, instead of the specific transaction details, as illustrated in FIG. 1. In FIG. 1, a transaction handler (103) processes payment transactions in a payment processing network to generate transaction data (109), which is used to generate transaction profiles (127), such as a user specific profile (131) of a user (101). A technique to generate an aggregated spending profile (341) of the user (101) is illustrated in FIG. 2 and further described in the section entitled “AGGREGATED SPENDING PROFILE.”

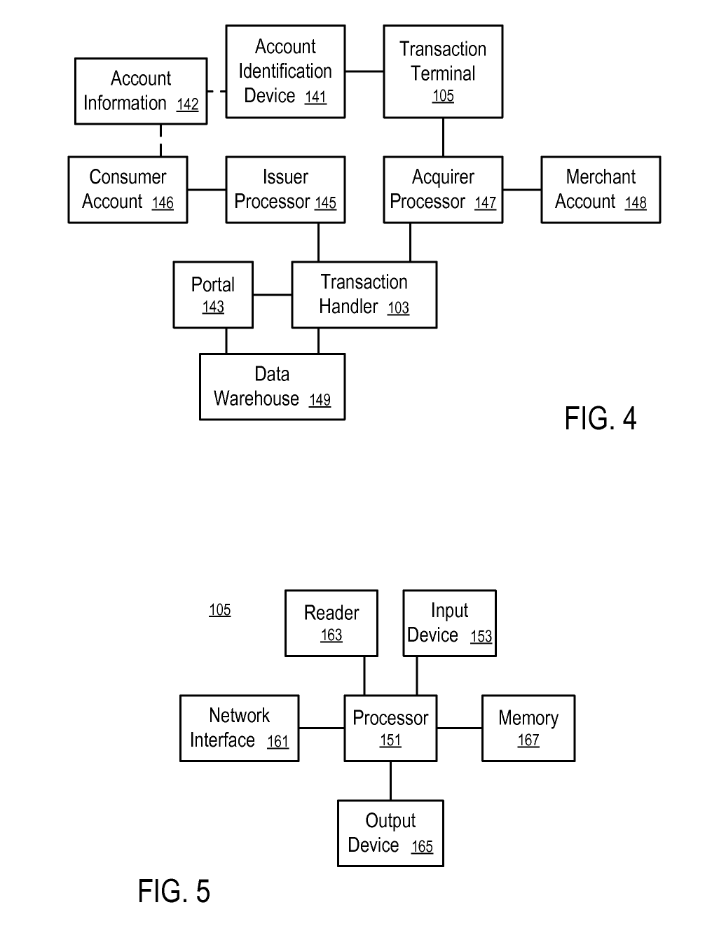

As illustrated in FIG. 4, the transaction handler (103) interconnects various issuer processors (e.g., 145) and acquirer processors (e.g., 147) in the payment transaction processing network. Thus, the transaction handler (103) is strategically located in the payment transaction processing network to observer transactions occurring within the network. The transaction handler (103) of the payment transaction processing network can record the transaction data for transactions made using consumer accounts (e.g., 146) under the control of various issuer processors (e.g., 145), made with merchants having merchant accounts (e.g., 148) under control of various acquirer processors (e.g., 147), and made in various purchase channels, such as online marketplaces, offline in retail stores, phone orders, etc. The transaction handler (103) has better visibility into transactions in the payment processing network than other components, such as the issuer processors (145) or the acquirer processors (148). Thus, the transaction data (109) recorded by the transaction handler (103) is preferred for linking various user data. However, the technique can also be used to link user data based on transaction data recorded by other payment processors in the payment transaction processing network, such as the issuer processors (145), the acquirer processors (147), etc.

An augmented tracking profile generated based on the transaction data or profile and/or the linked user data can be used for various purposes, such as targeting ads, determining effectiveness of offers, determining security risks of transactions, etc. For example, the section entitled “TRANSACTION DATA BASED SERVICES” provides some examples and details of such services.

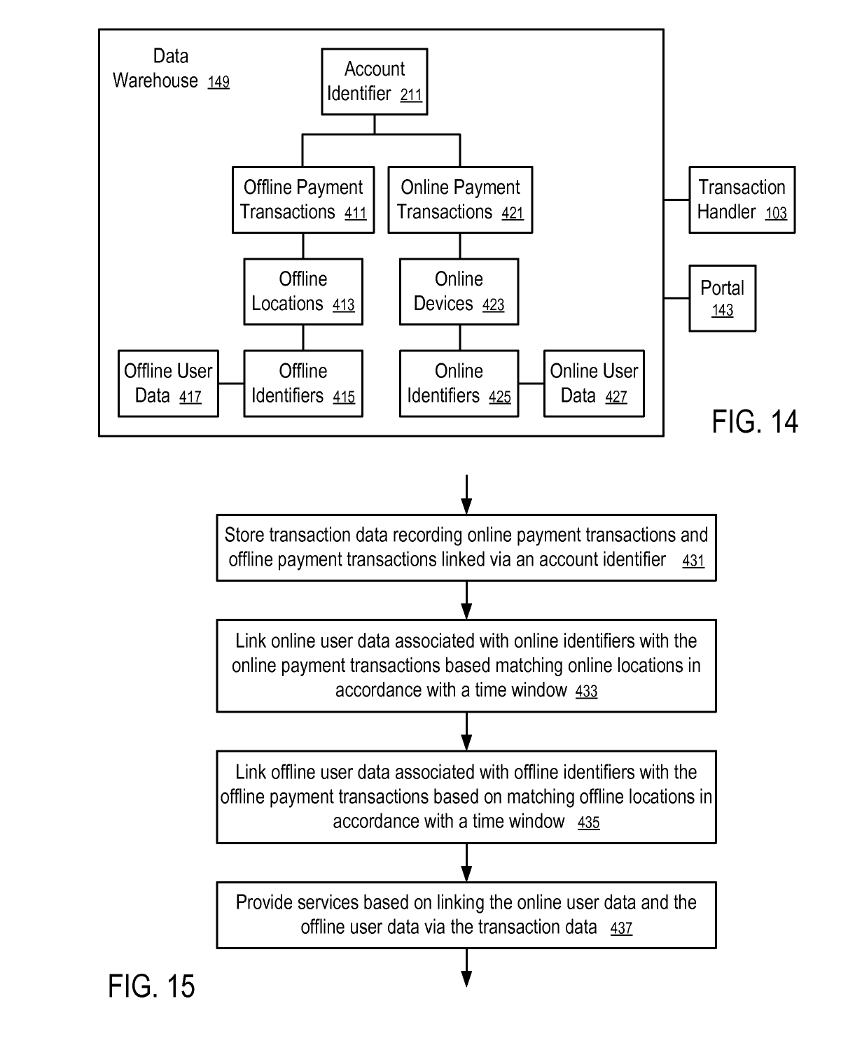

FIG. 14 shows a system to connect information via transaction data according to one embodiment.

In FIG. 14, the transaction handler (103) is configured to record, in a data warehouse (149), online payment transactions (421) and offline payment transactions (411) that are processed via the transaction handler (103).

In general, transactions processed by the transaction handler (103) are made via different account identifiers of consumer accounts issued to different users. In FIG. 14, the offline payment transactions (411) and the online payment transactions (421) that are made via a same account identifier (211) are illustrated. Through the common account identifier (211) that is used to make the offline payment transactions (411) and the online payment transactions (421), the offline payment transactions (411) are linked to the online payment transactions (421) in the data warehouse (149).

For example, the account identifier (211) may correspond to account information (142) illustrated in FIG. 4 to identify the consumer account (146) of a user (101) shown in FIG. 1. Thus, the online payment transactions (421) in the consumer account (146) and the offline payment transactions (411) in the consumer account (146) are linked to each other via the account identifier (211).

In FIG. 14, the online payment transactions (421) are associated with online devices (423) used to make or initiate the online payment transactions (421). For example, the online devices (423) used to make or initiate the online payment transactions (421) may be identified via parameters used in online communications, such as internet protocol (IP) address, media access control (MAC) address, mobile phone number, mobile station international subscriber directory number (MSISDN), hardware serial number, etc.

Information connecting the online payment transactions (421) and the online devices (423) may be received in the data warehouse (149) via the transaction handler (103) or a portal (143).

For example, when an online payment transaction (421) is submitted from a merchant to the payment processing network, the online payment transaction (421) may include the device identifiers of the corresponding online devices (423) of the users (101), such as a point of interaction (107) of the user (101) illustrated in FIG. 1. Device identifiers may include the IP address, the MAC address, MSISDN and/or the mobile phone number of the point of interaction (107) of the user (101) for submitting the payment request. The authorization request may be configured to include the device identifiers. When the transaction handler (103) processes such authorization requests, the transaction handler (103) stores the data linking the online payment transactions (421) with the online devices (423) represented by the device identifiers.

Alternatively or in combination, the online merchants may collect data associating the online payment transactions (421) with the online devices (423) and submit the data to the portal (143) separately from the authorization communications.

Independent from recording the data linking the online payment transactions (421) to online devices (423), the portal (143) is configured to receive online user data (427) generated user trackers, such as a user tracker (113) illustrated in FIG. 1.

For example, the user tracker (113) may track the user activities on the point of interaction (107) in an anonymous way, without requiring the user (101) to explicitly identify the user (101) on the point of interaction (107). For example, the user tracker (113) may use browser cookies to track user online activities, such as websites visited, webpages viewed, uniform resource locators (URLs) visited, advertisements being presented to, advertisements clicked, etc. The user tracker (113) may further collect user online behavior data, such as typing speed, typing pattern, device usage pattern, etc.

Online identifiers (425) may also include user identifiers explicitly submitted by the user (101) to identify the user (101). For example, the user identifiers may include user ID, member ID, a registration number, etc. that is configured to explicitly identify the user (101) as a particular user that has previously interacted with an online environment/community. In general, the data warehouse (149) is configured to match a plurality of online identifiers (425) used by different user trackers (e.g., 113) to the respective online payment transactions (421).

In FIG. 14, the online user data (427) are collected/tracked for online identifiers (425) of the user (101). Since the online user data (427) are typically generated by the user tracker (113) separate from the online merchant, the online user data (427) is typically unconnected to the online payment transactions (421).

In FIG. 14, the portal (143) is configured to link the online user data (427) with the online payment transactions (421). For example, the online user data (427) for the online identifiers (425) can be tracked in connection with the online devices (423). The portal (143) is configured to correlate the online payment transaction (421) with the online user data (427) based on matching their respectively associated online devices (423).

For example, the online devices (423) may be identified by device identifiers, such as IP address, the MAC address, MSISDN and/or the mobile phone number. A device identifier may be used by different users. However, when the device identifier used for an online payment transaction (421) is also observed to be associated with the online user data (427) within a predetermined time window, the probability is high that the online payment transaction (421) and the online user data (427) are connected. Further, when a set of online payment transactions (421), each have a higher probability of being above a threshold in being connected to the same online identifier (425) of a set of online user data (427), the set of online payment transactions (421) can be linked to the set of online user data (427).

For example, when the correlation between the use of the online devices (423) in the online payment transactions (421) and the use of the devices for the online user data (427) is above a threshold, the online identifier (425) of the online user data (427) can be connected to the online payment transactions (421).

The online activities in the online user data (427) are generally separate from the online payment transactions (421). However, when the online payment transaction (421) is observed to be occurring concurrent with the online activities of the online identifiers (425), the online identifiers (425) can be connected to the online payment transactions (421) and thus the account identifier (211) with high certainty. Details and examples of some methods and systems to connecting online identifiers (425) to the account identifier (211) are provided in the section entitled “COOKIE TO ACCOUNT.”

In matching the online payment transactions (421) with online user data (427), the portal (143) may match the data based on, not only the online locations (e.g., the online devices (423)) and times at the online locations, but also the context of the data. For example, the category of the online user data (427) may be matched with the merchant category of the online payment transactions (421).

In FIG. 14, the portal (143) is further configured to receive offline user data (427) and match offline user data (417) with corresponding offline payment transactions (411). For example, the offline user data (417) may include data collected in the retail stores of offline merchants, such as receipt information, coupon usage information, purchase details, loyalty information, reward program information, etc.

For example, the merchant may provide an anonymous reward program based on a punch card. An offline identifier (415) can be used to represent the punch card. When a certain requirement is satisfied, the punch card is punched. When a predetermined number of punches is present on the punch card, the user (101) may be rewarded with a gift, a discount, etc. The merchant system may track the use of the punch card and generate the offline user data (417).

For example, the merchant may provide a loyalty card that may or may not require the user (101) to reveal the identity of the user (101). The loyalty card may provide loyalty rewards. The merchant system may track the use of the loyalty card to generate the offline user data (417). The offline user data (417) may include the purchase details of purchases made in connection with the loyalty card, warrantee information, exchange and return information, etc.

For example, a transaction terminal (105) (illustrated in FIG. 1) of the merchant may record information about the user (101) when the user (101) makes transactions at the transaction terminal (105). The transaction terminal (105) may record the handwriting of the user (101), capture a facial image of the user (101), record a voice input of the user (101), capture the background noises while the user (101) is making the payment at the transaction terminal. The merchant system, including the transaction terminal (105), may capture the data as the offline user data (417) separately, or in connection with the offline payment transactions (411).

When the merchant system captures the offline user data (417) separately form the offline payment transactions (411), the portal (143) may match the offline payment transactions (411) with the offline user data (417) based on offline locations (413) and the times at the offline locations.

For example, the transaction terminal (105) may submit authorization requests for the offline payment transactions (411) with location information, such as locations determined by the GPS receivers integrated in, or co-located with, the transaction terminal (105). Alternatively, the GPS locations of the transaction terminal (105) can be registered in the data warehouse (149) during a registration process, such that when the authorization request is determined to be from the transaction terminal (105), the GPS location of the transaction can be determined. Alternatively, the location of the transaction terminal (105) may be identified via a street address, or on an interactive map.

When a user location of the offline user activity in the offline user data (417) matches the location of a transaction within a predetermined time window, the offline user data (417) can be connected to the offline payment transactions (411).

For example, when multiple user activities in the offline user data (417) match with multiple offline payment transactions (411) according to a predetermine time window, the offline user data (417) can be linked to the offline payment transactions (411).

In FIG. 14, through the common link to the account identifiers (211), the online payment transactions (421) are linked to the offline payment transactions (411). When the online user data (427) is connected to the respective online payment transactions (411), and the offline user data (417) is connected to the respective offline payment transactions (411), the online user (427) and the offline user data (417) are connected with each other via the online/offline payment transactions (421 and 411, respectively).

In some instances, an online identifier (425), or an offline identifier (415), is connected to more than one account identifier (211) with a certainty above a threshold, in accordance with the data matching operations. Thus, the online user data (427) and the offline user data (417) are connected to not only the payment transactions (421, 411) of the account identifier (211), but also the transactions using other account identifiers of the user (101). The interconnected information about the online activities, offline activities, and payment transactions (421, 411) provide a comprehensive profile of the user (101). The comprehensive profile can be summarized and/or annonymized to provide information about the user (101) without compromising the privacy of the user (101).

For example, the transactions of the linked account identifiers (211) of the user (101), linked with the connections to common online identifiers (425) or offline identifiers (415) of the user (101) can be summarized to generate an aggregated spending profile (341) of the user (101), as illustrated in FIG. 2 and discussed in the section entitled “AGGREGATED SPENDING PROFILE.”

FIG. 15 shows a method to connect information via transaction data according to one embodiment. For example, the method of FIG. 15 can be implemented in the system illustrated in FIG. 14.

In FIG. 15, a computing apparatus is configured to: store (431) transaction data (109) recording online payment transactions (421) and offline payment transactions (411) linked via an account identifier (211); link (433) online user data (427) associated with online identifiers (425) with the online payment transactions (421) based on matching online locations (413) (e.g., represented by the online devices (423)) in accordance with a time window; link (435) offline user data (417) associated with offline identifiers (415) with the offline payment transactions (411) based on matching offline locations (413) in accordance with a time window (which may or may not be the same as the time window for matching online user data (427) to online payment transactions (421)); and provide (437) services based on linking the online user data (427) and the offline user data (417) via the transaction data (109).

For example, the computing apparatus may be implemented using one or more data processing systems illustrated in FIG. 7, where each of the data processing systems has at least one microprocessor (173) and memory (167) storing instructions configured to instruct the at least one microprocessor (173) to perform operations.

The computing apparatus may include: a payment processor (e.g., the transaction handler (103), the issuer processor (145), or the acquirer processor (147)) configured to process payment transactions in a payment processing network and generate transaction data (109), recording the payment transactions processed by the payment processor (e.g., 103, 145, or 147); a portal (143) configured to receive, separate from payment processing in the payment processing network, non-transaction data (e.g., online user data (427), offline user data (417)) that is generated from anonymously tracking user activities by third party user trackers (113); and a data warehouse (149) coupled with the portal (143) and the payment processor (e.g., 103, 145, or 147) to store the transaction data (109) generated by the payment processor (e.g., 103, 145, or 147), and the non-transaction data (e.g., 417, 427) received by the portal (143).

In the computing apparatus, the data warehouse (149) is configured to store offline user data (417) in association with offline identifiers (415) of the user (101) and link offline payment transactions (411) to the offline identifiers (415) of the user (101), where the offline payment transactions (411) are made by using an account identifier (211) of the user (101) at offline retail locations (413) of merchants. The data warehouse (149) is further configured to store online user data (427) in association with online identifiers (425) of the user (101) and link online payment transactions (421) to the online identifiers (425) of online devices (423) used by the user (101), where the online payment transactions (421) are made by using the same account identifier (211) of the user (101) in e-commerce environments, and the online identifiers (425) are configured to anonymously track user online activities. Thus, the data warehouse (149) links the offline user data (417) to the online user data (427) via the link between the respective associated offline payment transactions (411) and online payment transactions (421).

For example, the non-transaction data may include locations determined by a global positioning system receiver of the user (101), and the computing apparatus is configured to match a location determined by the global positioning system receiver of the user (101) with a location determined by a global position system receiver of a merchant to associate an identifier of the user (101) with an offline transaction (411) of the user (101). The identifier of the user (101) is an offline identifier (415) (and/or an online identifier (425) in some instances).

For example, the computing apparatus can be further configured to match transactions (e.g., 411, 421) with identifiers (e.g., 415, 425) of the user (101) based on transaction locations (e.g., corresponding to 413, 423) in the transaction data (109) and user activity locations (e.g., corresponding to 413, 423) in the non-transaction data (e.g., 417, 427). The transaction locations and the user activity locations can be online locations (e.g., corresponding to 423), or offline locations (e.g., corresponding to 413) in retail stores of merchants.

For example, the computing apparatus can be further configured to perform data matching to link the online identifiers (425), such as browser cookies for anonymous tracking, to the online payment transactions (421), where the data matching can be based on device identifiers, such as a mobile phone number, internet protocol address, media access control address, or mobile station international subscriber directory number.

For example, the computing apparatus can be further configured to perform data matching to link the offline identifiers (415) to the offline payment transactions (411), based on offline locations (413) and time periods of the offline locations (413). The offline locations (413) may be determined by global positioning system receivers of a mobile device of the user (101) and/or the transaction terminals of merchants.

For example, the portal (143) can be further configured to receive a request identifying a first identifier, and in response, the computing system is further configured via the instructions to determine that the first identifier is in association with the account identifier (211) of the user (101) in the data warehouse (149); generate an anonymized profile (e.g., 131, 341) of the user (101) based on the offline user data (417), the online user data (427), the offline payment transactions (411) and/or the online payment transactions (421); and provide the anonymized profile (e.g., 131, 341) of the user (101) as a response to the request.

The computing apparatus can be further implemented, optionally, to perform other operations discussed below, such as the operations discussed in the section entitled “TRANSACTION DATA BASED SERVICES.” Some of the hardware arrangements are discussed in the sections entitled “CENTRALIZED DATA WAREHOUSE” and “HARDWARE.”

### Transaction Data Based Services

FIG. 1 illustrates a system to provide services based on transaction data according to one embodiment. In FIG. 1, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 1, the system further includes a correlator (117) to correlate user specific advertisement data (119) with transactions resulting from the user specific advertisement data (119). The correlation results (123) can be used by the profile generator (121) to improve the transaction profiles (127).

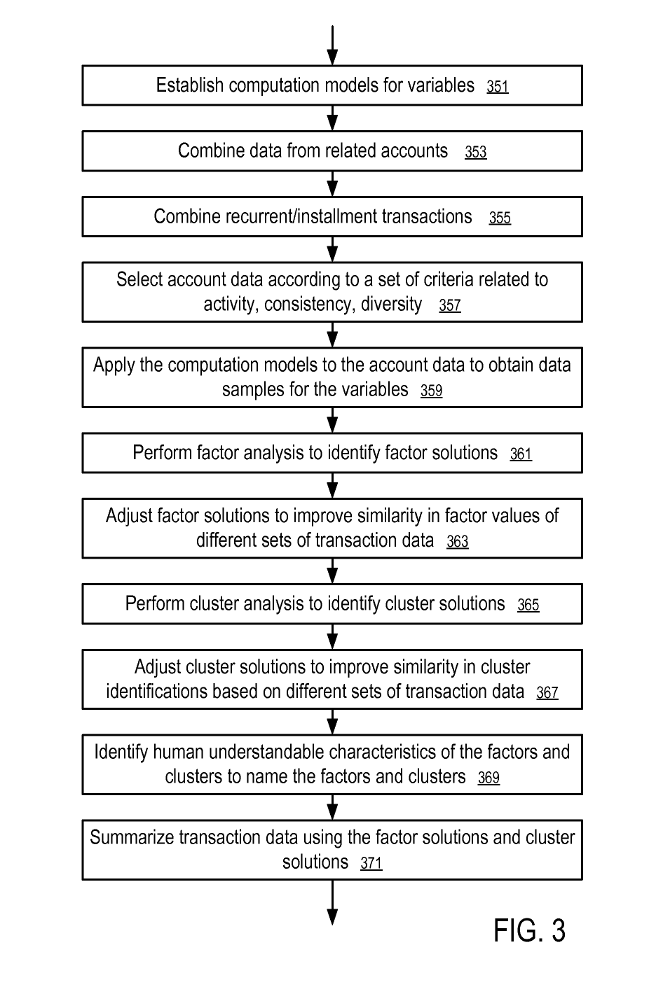

The transaction profiles (127) of one embodiment are generated from the transaction data (109) in a way as illustrated in FIGS. 2 and 3. For example, in FIG. 2, an aggregated spending profile (341) is generated via the factor analysis (327) and cluster analysis (329) to summarize (335) the spending patterns/behaviors reflected in the transaction records (301).

In one embodiment, a data warehouse (149) as illustrated in FIG. 4 is coupled with the transaction handler (103) to store the transaction data (109) and other data, such as account data (111), transaction profiles (127) and correlation results (123). In FIG. 4, a portal (143) is coupled with the data warehouse (149) to provide data or information derived from the transaction data (109), in response to a query request from a third party or as an alert or notification message.

In FIG. 4, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

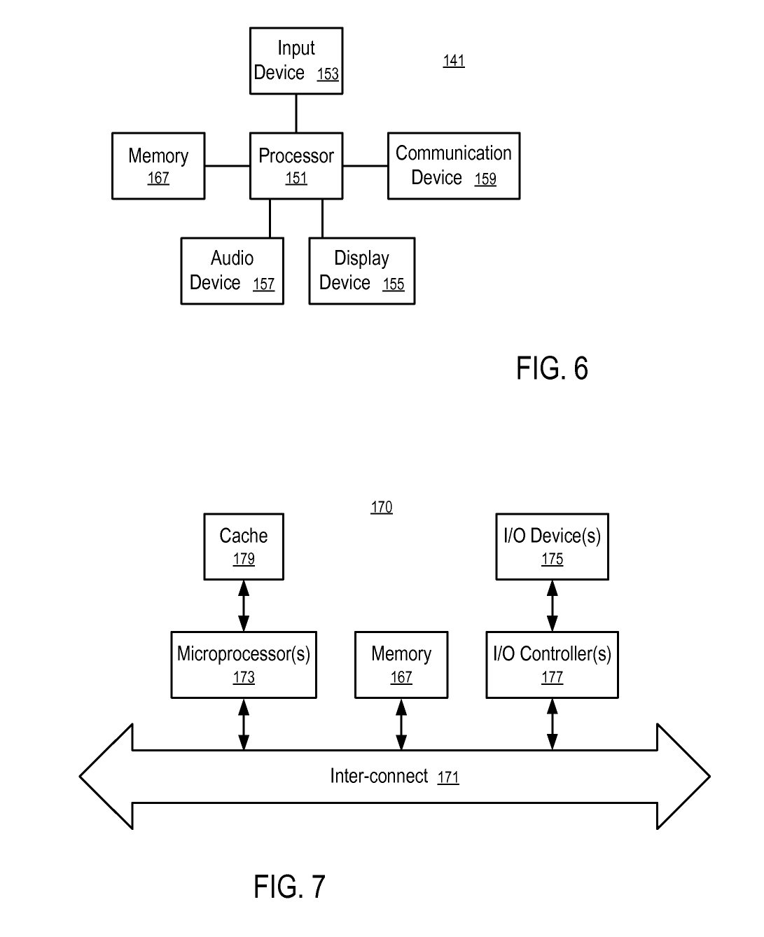

FIGS. 5 and 6 illustrate examples of transaction terminals (105) and account identification devices (141). FIG. 7 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated, such as, in FIGS. 1, 4-7, and other figures, as further discussed in the section entitled “VARIATIONS.”

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127, 341).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section. For example, the centralized data warehouse (149) may include the advertisement data (135) and/or offers of benefits such as discount, reward, points, cashback, etc. The offers can be communicated to the users (e.g., 101) via the advertisement data (135) or as part of the advertisement data (135).

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records (301) between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In FIG. 1, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) (and/or the portal (143)) is configured to provide at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The profile generator (121) may generate and update the transaction profiles (127) in batch mode periodically, or generates the transaction profiles (127) in real time, or just in time, in response to a request received in the portal (143) for such profiles.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles (127) in one embodiment are provided in the section entitled “AGGREGATED SPENDING PROFILE.”

### Non-Transactional Data

In one embodiment, the transaction data (109) is analyzed in connection with non-transactional data to generate transaction profiles (127) and/or to make predictive models.

In one embodiment, transactions are correlated with non-transactional events, such as news, conferences, shows, announcements, market changes, natural disasters, etc. to establish cause and effect relations to predict future transactions or spending patterns. For example, non-transactional data may include the geographic location of a news event, the date of an event from an events calendar, the name of a performer for an upcoming concert, etc. The non-transactional data can be obtained from various sources, such as newspapers, websites, blogs, social networking sites, etc.

When the cause and effect relationships between the transactions and non-transactional events are known (e.g., based on prior research results, domain knowledge, expertise), the relationships can be used in predictive models to predict future transactions or spending patterns, based on events that occurred recently or are happening in real time.

In one embodiment, the non-transactional data relates to events that happened in a geographical area local to the user (101) that performed the respective transactions. In one embodiment, a geographical area is local to the user (101) when the distance from the user (101) to locations in the geographical area is within a convenient range for daily or regular travel, such as 20, 50 or 100 miles from an address of the user (101), or within the same city or zip code area of an address of the user (101). Examples of analyses of local non-transactional data in connection with transaction data (109) in one embodiment are provided in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the non-transactional data is not limited to local non-transactional data. For example, national non-transactional data can also be used.

In one embodiment, the transaction records (301) are analyzed in frequency domain to identify periodic features in spending events. The periodic features in the past transaction records (301) can be used to predict the probability of a time window in which a similar transaction would occur. For example, the analysis of the transaction data (109) can be used to predict when a next transaction having the periodic feature would occur, with which merchant, the probability of a repeated transaction with a certain amount, the probability of exception, the opportunity to provide an advertisement or offer such as a coupon, etc. In one embodiment, the periodic features are detected through counting the number of occurrences of pairs of transactions that occurred within a set of predetermined time intervals and separating the transaction pairs based on the time intervals. Some examples and techniques for the prediction of future transactions based on the detection of periodic features in one embodiment are provided in U.S. patent application Ser. No. 12/773,770, filed May 4, 2010, assigned U.S. Pat. App. Pub. No. 2010/0280882, and entitled “Frequency-Based Transaction Prediction and Processing,” the disclosure of which is hereby incorporated herein by reference.

Techniques and details of predictive modeling in one embodiment are provided in U.S. Pat. Nos. 6,119,103, 6,018,723, 6,658,393, 6,598,030, and 7,227,950, the disclosures of which are hereby incorporated herein by reference.

In one embodiment, offers are based on the point-of-service to offeree distance to allow the user (101) to obtain in-person services. In one embodiment, the offers are selected based on transaction history and shopping patterns in the transaction data (109) and/or the distance between the user (101) and the merchant. In one embodiment, offers are provided in response to a request from the user (101), or in response to a detection of the location of the user (101). Examples and details of at least one embodiment are provided in U.S. patent application Ser. No. 11/767,218, filed Jun. 22, 2007, assigned U.S. Pat. App. Pub. No. 2008/0319843, and entitled “Supply of Requested Offer Based on Point-of Service to Offeree Distance,” U.S. patent application Ser. No. 11/755,575, filed May 30, 2007, assigned U.S. Pat. App. Pub. No. 2008/0300973, and entitled “Supply of Requested Offer Based on Offeree Transaction History,” U.S. patent application Ser. No. 11/855,042, filed Sep. 13, 2007, assigned U.S. Pat. App. Pub. No. 2009/0076896, and entitled “Merchant Supplied Offer to a Consumer within a Predetermined Distance,” U.S. patent application Ser. No. 11/855,069, filed Sep. 13, 2007, assigned U.S. Pat. App. Pub. No. 2009/0076925, and entitled “Offeree Requested Offer Based on Point-of Service to Offeree Distance,” and U.S. patent application Ser. No. 12/428,302, filed Apr. 22, 2009, assigned U.S. Pat. App. Pub. No. 2010/0274627, and entitled “Receiving an Announcement Triggered by Location Data,” the disclosures of which applications are hereby incorporated herein by reference.

### Targeting Advertisement

In FIG. 1, an advertisement selector (133) prioritizes, generates, selects, adjusts, and/or customizes the available advertisement data (135) to provide user specific advertisement data (119) based at least in part on the user specific profile (131). The advertisement selector (133) uses the user specific profile (131) as a filter and/or a set of criteria to generate, identify, select and/or prioritize advertisement data for the user (101). A media controller (115) delivers the user specific advertisement data (119) to the point of interaction (107) for presentation to the user (101) as the targeted and/or personalized advertisement.

In one embodiment, the user data (125) includes the characterization of the context at the point of interaction (107). Thus, the use of the user specific profile (131), selected using the user data (125), includes the consideration of the context at the point of interaction (107) in selecting the user specific advertisement data (119).

In one embodiment, in selecting the user specific advertisement data (119), the advertisement selector (133) uses not only the user specific profile (131), but also information regarding the context at the point of interaction (107). For example, in one embodiment, the user data (125) includes information regarding the context at the point of interaction (107); and the advertisement selector (133) explicitly uses the context information in the generation or selection of the user specific advertisement data (119).

In one embodiment, the advertisement selector (133) may query for specific information regarding the user (101) before providing the user specific advertisement data (119). The queries may be communicated to the operator of the transaction handler (103) and, in particular, to the transaction handler (103) or the profile generator (121). For example, the queries from the advertisement selector (133) may be transmitted and received in accordance with an application programming interface or other query interface of the transaction handler (103), the profile generator (121) or the portal (143) of the transaction handler (103).

In one embodiment, the queries communicated from the advertisement selector (133) may request intelligence information regarding the user (101) at any level of specificity (e.g., segment level, individual level). For example, the queries may include a request for a certain field or type of information in a cardholder's aggregate spending profile (341). As another example, the queries may include a request for the spending level of the user (101) in a certain merchant category over a prior time period (e.g., six months).

In one embodiment, the advertisement selector (133) is operated by an entity that is separate from the entity that operates the transaction handler (103). For example, the advertisement selector (133) may be operated by a search engine, a publisher, an advertiser, an ad network, or an online merchant. The user specific profile (131) is provided to the advertisement selector (133) to assist the customization of the user specific advertisement data (119).

In one embodiment, advertising is targeted based on shopping patterns in a merchant category (e.g., as represented by a Merchant Category Code (MCC)) that has high correlation of spending propensity with other merchant categories (e.g., other MCCs). For example, in the context of a first MCC for a targeted audience, a profile identifying second MCCs that have high correlation of spending propensity with the first MCC can be used to select advertisements for the targeted audience.

In one embodiment, the aggregated spending profile (341) is used to provide intelligence information about the spending patterns, preferences, and/or trends of the user (101). For example, a predictive model can be established based on the aggregated spending profile (341) to estimate the needs of the user (101). For example, the factor values (344) and/or the cluster ID (343) in the aggregated spending profile (341) can be used to determine the spending preferences of the user (101). For example, the channel distribution (345) in the aggregated spending profile (341) can be used to provide a customized offer targeted for a particular channel, based on the spending patterns of the user (101).

In one embodiment, mobile advertisements, such as offers and coupons, are generated and disseminated based on aspects of prior purchases, such as timing, location, and nature of the purchases, etc. In one embodiment, the size of the benefit of the offer or coupon is based on purchase volume or spending amount of the prior purchase and/or the subsequent purchase that may qualify for the redemption of the offer. Further details and examples of one embodiment are provided in U.S. patent application Ser. No. 11/960,162, filed Dec. 19, 2007, assigned U.S. Pat. App. Pub. No. 2008/0201226, and entitled “Mobile Coupon Method and Portable Consumer Device for Utilizing Same,” the disclosure of which is hereby incorporated herein by reference.

In one embodiment, conditional rewards are provided to the user (101); and the transaction handler (103) monitors the transactions of the user (101) to identify redeemable rewards that have satisfied the respective conditions. In one embodiment, the conditional rewards are selected based on transaction data (109). Further details and examples of one embodiment are provided in U.S. patent application Ser. No. 11/862,487, filed Sep. 27, 2007, assigned U.S. Pat. App. Pub. No. 2008/0082418, and entitled “Consumer Specific Conditional Rewards,” the disclosure of which is hereby incorporated herein by reference. The techniques to detect the satisfied conditions of conditional rewards can also be used to detect the transactions that satisfy the conditions specified to locate the transactions that result from online activities, such as online advertisements, searches, etc., to correlate the transactions with the respective online activities.

Further details about targeted offer delivery in one embodiment are provided in U.S. patent application Ser. No. 12/185,332, filed Aug. 4, 2008, assigned U.S. Pat. App. Pub. No. 2010/0030644, and entitled “Targeted Advertising by Payment Processor History of Cashless Acquired Merchant Transaction on Issued Consumer Account,” and in U.S. patent application Ser. No. 12/849,793, filed Aug. 3, 2010, assigned U.S. Pat. App. Pub. No. 2011/0035280, and entitled “Systems and Methods for Targeted Advertisement Delivery,” the disclosures of which applications are hereby incorporated herein by reference.

### Profile Matching

In FIG. 1, the user tracker (113) obtains and generates context information about the user (101) at the point of interaction (107), including user data (125) that characterizes and/or identifies the user (101). The profile selector (129) selects a user specific profile (131) from the set of transaction profiles (127) generated by the profile generator (121), based on matching the characteristics of the transaction profiles (127) and the characteristics of the user data (125). For example, the user data (125) indicates a set of characteristics of the user (101); and the profile selector (129) selects the user specific profile (131) that is for a particular user or a group of users and that best matches the set of characteristics specified by the user data (125).

In one embodiment, the profile selector (129) receives the transaction profiles (127) in a batch mode. The profile selector (129) selects the user specific profile (131) from the batch of transaction profiles (127) based on the user data (125). Alternatively, the profile generator (121) generates the transaction profiles (127) in real time; and the profile selector (129) uses the user data (125) to query the profile generator (121) to generate the user specific profile (131) in real time, or just in time. The profile generator (121) generates the user specific profile (131) that best matches the user data (125).

In one embodiment, the user tracker (113) identifies the user (101) based on the user activity on the transaction terminal (105) (e.g., having visited a set of websites, currently visiting a type of web pages, search behavior, etc.).

In one embodiment, the user data (125) includes an identifier of the user (101), such as a global unique identifier (GUID), a personal account number (PAN) (e.g., credit card number, debit card number, or other card account number), or other identifiers that uniquely and persistently identify the user (101) within a set of identifiers of the same type. Alternatively, the user data (125) may include other identifiers, such as an Internet Protocol (IP) address of the user (101), a name or user name of the user (101), or a browser cookie ID, which identify the user (101) in a local, temporary, transient and/or anonymous manner. Some of these identifiers of the user (101) may be provided by publishers, advertisers, ad networks, search engines, merchants, or the user tracker (113). In one embodiment, such identifiers are correlated to the user (101) based on the overlapping or proximity of the time period of their usage to establish an identification reference table.

In one embodiment, the identification reference table is used to identify the account information (142) (e.g., account number (302)) based on characteristics of the user (101) captured in the user data (125), such as browser cookie ID, IP addresses, and/or timestamps on the usage of the IP addresses. In one embodiment, the identification reference table is maintained by the operator of the transaction handler (103). Alternatively, the identification reference table is maintained by an entity other than the operator of the transaction handler (103).

In one embodiment, the user tracker (113) determines certain characteristics of the user (101) to describe a type or group of users of which the user (101) is a member. The transaction profile of the group is used as the user specific profile (131). Examples of such characteristics include geographical location or neighborhood, types of online activities, specific online activities, or merchant propensity. In one embodiment, the groups are defined based on aggregate information (e.g., by time of day, or household), or segment (e.g., by cluster, propensity, demographics, cluster IDs, and/or factor values). In one embodiment, the groups are defined in part via one or more social networks. For example, a group may be defined based on social distances to one or more users on a social network website, interactions between users on a social network website, and/or common data in social network profiles of the users in the social network website.

In one embodiment, the user data (125) may match different profiles at a different granularity or resolution (e.g., account, user, family, company, neighborhood, etc.), with different degrees of certainty. The profile selector (129) and/or the profile generator (121) may determine or select the user specific profile (131) with the finest granularity or resolution with acceptable certainty. Thus, the user specific profile (131) is most specific or closely related to the user (101).

In one embodiment, the advertisement selector (133) uses further data in prioritizing, selecting, generating, customizing and adjusting the user specific advertisement data (119). For example, the advertisement selector (133) may use search data in combination with the user specific profile (131) to provide benefits or offers to a user (101) at the point of interaction (107). For example, the user specific profile (131) can be used to personalize the advertisement, such as adjusting the placement of the advertisement relative to other advertisements, adjusting the appearance of the advertisement, etc.

### Browser Cookie

In one embodiment, the user data (125) uses browser cookie information to identify the user (101). The browser cookie information is matched to account information (142) or the account number (302) to identify the user specific profile (131), such as aggregated spending profile (341) to present effective, timely, and relevant marketing information to the user (101), via the preferred communication channel (e.g., mobile communications, web, mail, email, POS, etc.) within a window of time that could influence the spending behavior of the user (101). Based on the transaction data (109), the user specific profile (131) can improve audience targeting for online advertising. Thus, customers will get better advertisements and offers presented to them; and the advertisers will achieve better return-on-investment for their advertisement campaigns.

In one embodiment, the browser cookie that identifies the user (101) in online activities, such as web browsing, online searching, and using social networking applications, can be matched to an identifier of the user (101) in account data (111), such as the account number (302) of a financial payment card of the user (101) or the account information (142) of the account identification device (141) of the user (101). In one embodiment, the identifier of the user (101) can be uniquely identified via matching IP address, timestamp, cookie ID and/or other user data (125) observed by the user tracker (113).

In one embodiment, a look up table is used to map browser cookie information (e.g., IP address, timestamp, cookie ID) to the account data (111) that identifies the user (101) in the transaction handler (103). The look up table may be established via correlating overlapping or common portions of the user data (125) observed by different entities or different user trackers (113).

For example, in one embodiment, a first user tracker (113) observes the card number of the user (101) at a particular IP address for a time period identified by a timestamp (e.g., via an online payment process); a second user tracker (113) observes the user (101) having a cookie ID at the same IP address for a time period near or overlapping with the time period observed by the first user tracker (113). Thus, the cookie ID as observed by the second user tracker (113) can be linked to the card number of the user (101) as observed by the first user tracker (113). The first user tracker (113) may be operated by the same entity operating the transaction handler (103) or by a different entity. Once the correlation between the cookie ID and the card number is established via a database or a look up table, the cookie ID can be subsequently used to identify the card number of the user (101) and the account data (111).

In one embodiment, the portal (143) is configured to observe a card number of a user (101) while the user (101) uses an IP address to make an online transaction. Thus, the portal (143) can identify a consumer account (146) based on correlating an IP address used to identify the user (101) and IP addresses recorded in association with the consumer account (146).

For example, in one embodiment, when the user (101) makes a payment online by submitting the account information (142) to the transaction terminal (105) (e.g., an online store), the transaction handler (103) obtains the IP address from the transaction terminal (105) via the acquirer processor (147). The transaction handler (103) stores data to indicate the use of the account information (142) at the IP address at the time of the transaction request. When an IP address in the query received in the portal (143) matches the IP address previously recorded by the transaction handler (103), the portal (143) determines that the user (101) identified by the IP address in the request is the same user (101) associated with the account of the transaction initiated at the IP address. In one embodiment, a match is found when the time of the query request is within a predetermined time period from the transaction request, such as a few minutes, one hour, a day, etc. In one embodiment, the query may also include a cookie ID representing the user (101). Thus, through matching the IP address, the cookie ID is associated with the account information (142) in a persistent way.

In one embodiment, the portal (143) obtains the IP address of the online transaction directly. For example, in one embodiment, a user (101) chooses to use a password in the account data (111) to protect the account information (142) for online transactions. When the account information (142) is entered into the transaction terminal (105) (e.g., an online store or an online shopping cart system), the user (101) is connected to the portal (143) for the verification of the password (e.g., via a pop up window, or via redirecting the web browser of the user (101)). The transaction handler (103) accepts the transaction request after the password is verified via the portal (143). Through this verification process, the portal (143) and/or the transaction handler (103) obtain the IP address of the user (101) at the time the account information (142) is used.

In one embodiment, the web browser of the user (101) communicates the user provided password to the portal (143) directly without going through the transaction terminal (105) (e.g., the server of the merchant). Alternatively, the transaction terminal (105) and/or the acquirer processor (147) may relay the password communication to the portal (143) or the transaction handler (103).

In one embodiment, the portal (143) is configured to identify the consumer account (146) based on the IP address identified in the user data (125) through mapping the IP address to a street address. For example, in one embodiment, the user data (125) includes an IP address to identify the user (101); and the portal (143) can use a service to map the IP address to a street address. For example, an Internet service provider knows the street address of the currently assigned IP address. Once the street address is identified, the portal (143) can use the account data (111) to identify the consumer account (146) that has a current address at the identified street address. Once the consumer account (146) is identified, the portal (143) can provide a transaction profile (131) specific to the consumer account (146) of the user (101).

In one embodiment, the portal (143) uses a plurality of methods to identify consumer accounts (146) based on the user data (125). The portal (143) combines the results from the different methods to determine the most likely consumer account (146) for the user data (125).

Details about the identification of consumer account (146) based on user data (125) in one embodiment are provided in U.S. patent application Ser. No. 12/849,798, filed Aug. 3, 2010, assigned U.S. Pat. App. Pub. No. 2011/0093327, and entitled “Systems and

Methods to Match Identifiers,” the disclosure of which is hereby incorporated herein by reference.

### Close the Loop

In one embodiment, the correlator (117) is used to “close the loop” for the tracking of consumer behavior across an on-line activity and an “off-line” activity that results at least in part from the on-line activity. In one embodiment, online activities, such as searching, web browsing, social networking, and/or consuming online advertisements, are correlated with respective transactions to generate the correlation result (123) in FIG. 1. The respective transactions may occur offline, in “brick and mortar” retail stores, or online but in a context outside the online activities, such as a credit card purchase that is performed in a way not visible to a search company that facilitates the search activities.

The correlator (117) is configured in one embodiment to identify transactions resulting from searches or online advertisements. For example, in response to a query about the user (101) from the user tracker (113), the correlator (117) identifies an offline transaction performed by the user (101) and sends the correlation result (123) about the offline transaction to the user tracker (113), which allows the user tracker (113) to combine the information about the offline transaction and the online activities to provide significant marketing advantages.

For example, a marketing department could correlate an advertising budget to actual sales. For example, a marketer can use the correlation result (123) to study the effect of certain prioritization strategies, customization schemes, etc. on the impact on the actual sales. For example, the correlation result (123) can be used to adjust or prioritize advertisement placement on a web site, a search engine, a social networking site, an online marketplace, or the like.

In one embodiment, the profile generator (121) uses the correlation result (123) to augment the transaction profiles (127) with data indicating the rate of conversion from searches or advertisements to purchase transactions. In one embodiment, the correlation result (123) is used to generate predictive models to determine what a user (101) is likely to purchase when the user (101) is searching using certain keywords or when the user (101) is presented with an advertisement or offer. In one embodiment, the portal (143) is configured to report the correlation result (123) to a partner, such as a search engine, a publisher, or a merchant, to allow the partner to use the correlation result (123) to measure the effectiveness of advertisements and/or search result customization, to arrange rewards, etc.

In one embodiment, the correlator (117) matches the online activities and the transactions based on matching the user data (125) provided by the user tracker (113) and the records of the transactions, such as transaction data (109) or transaction records (301). In another embodiment, the correlator (117) matches the online activities and the transactions based on the redemption of offers/benefits provided in the user specific advertisement data (119).

In one embodiment, the portal (143) is configured to receive a set of conditions and an identification of the user (101), determine whether there is any transaction of the user (101) that satisfies the set of conditions, and if so, provide indications of the transactions that satisfy the conditions and/or certain details about the transactions, which allows the requester to correlate the transactions with certain user activities, such as searching, web browsing, consuming advertisements, etc.

In one embodiment, the requester may not know the account number (302) of the user (101); and the portal (143) is to map the identifier provided in the request to the account number (302) of the user (101) to provide the requested information. Examples of the identifier being provided in the request to identify the user (101) include an identification of an iFrame of a web page visited by the user (101), a browser cookie ID, an IP address and the day and time corresponding to the use of the IP address, etc.

The information provided by the portal (143) can be used in pre-purchase marketing activities, such as customizing content or offers, prioritizing content or offers, selecting content or offers, etc., based on the spending pattern of the user (101). The content that is customized, prioritized, selected, or recommended may be the search results, blog entries, items for sale, etc.

The information provided by the portal (143) can be used in post-purchase activities. For example, the information can be used to correlate an offline purchase with online activities. For example, the information can be used to determine purchases made in response to media events, such as television programs, advertisements, news announcements, etc.

Details about profile delivery, online activity to offline purchase tracking, techniques to identify the user specific profile (131) based on user data (125) (such as IP addresses), and targeted delivery of advertisement/offer/benefit in some embodiments are provided in U.S. patent application Ser. No. 12/849,789, filed Aug. 3, 2010, assigned U.S. Pat. App. Pub. No. 2011/0035278, and entitled “Systems and Methods for Closing the Loop between Online Activities and Offline Purchases,” the disclosure of which application is incorporated herein by reference.

### Loyalty Program

In one embodiment, the transaction handler (103) uses the account data (111) to store information for third party loyalty programs.

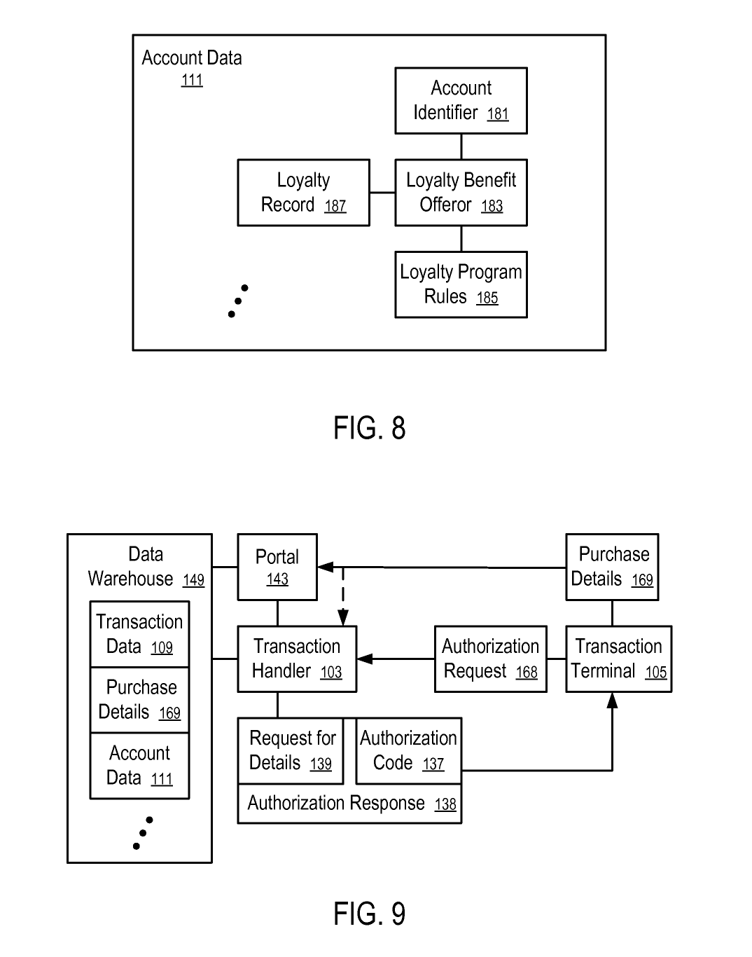

FIG. 8 shows the structure of account data (111) for providing loyalty programs according to one embodiment. In FIG. 8, data related to a third party loyalty program may include an identifier of the loyalty benefit offeror (183) that is linked to a set of loyalty program rules (185) and loyalty record (187) for the loyalty program activities of the account identifier (181). In one embodiment, at least part of the data related to the third party loyalty program is stored under the account identifier (181) of the user (101), such as the loyalty record (187).

FIG. 8 illustrates the data related to one third party loyalty program of a loyalty benefit offeror (183). In one embodiment, the account identifier (181) may be linked to multiple loyalty benefit offerors (e.g., 183), corresponding to different third party loyalty programs. The third party loyalty program of the loyalty benefit offeror (183) provides the user (101), identified by the account identifier (181), with benefits, such as discounts, rewards, incentives, cash back, gifts, coupons, and/or privileges.

In one embodiment, the association between the account identifier (181) and the loyalty benefit offeror (183) in the account data (111) indicates that the user (101) having the account identifier (181) is a member of the loyalty program. Thus, the user (101) may use the account identifier (181) to access privileges afforded to the members of the loyalty programs, such as rights to access a member only area, facility, store, product or service, discounts extended only to members, or opportunities to participate in certain events, buy certain items, or receive certain services reserved for members.

In one embodiment, it is not necessary to make a purchase to use the privileges. The user (101) may enjoy the privileges based on the status of being a member of the loyalty program. The user (101) may use the account identifier (181) to show the status of being a member of the loyalty program.

For example, the user (101) may provide the account identifier (181) (e.g., the account number of a credit card) to the transaction terminal (105) to initiate an authorization process for a special transaction which is designed to check the member status of the user (101), as if the account identifier (181) were used to initiate an authorization process for a payment transaction. The special transaction is designed to verify the member status of the user (101) via checking whether the account data (111) is associated with the loyalty benefit offeror (183). If the account identifier (181) is associated with the corresponding loyalty benefit offeror (183), the transaction handler (103) provides an approval indication in the authorization process to indicate that the user (101) is a member of the loyalty program. The approval indication can be used as a form of identification to allow the user (101) to access member privileges, such as access to services, products, opportunities, facilities, discounts, permissions, which are reserved for members.

In one embodiment, when the account identifier (181) is used to identify the user (101) as a member to access member privileges, the transaction handler (103) stores information about the access of the corresponding member privilege in loyalty record (187). The profile generator (121) may use the information accumulated in the loyalty record (187) to enhance transaction profiles (127) and provide the user (101) with personalized/targeted advertisements, with or without further offers of benefit (e.g., discounts, incentives, rebates, cash back, rewards, etc.).

In one embodiment, the association of the account identifier (181) and the loyalty benefit offeror (183) also allows the loyalty benefit offeror (183) to access at least a portion of the account data (111) relevant to the loyalty program, such as the loyalty record (187) and certain information about the user (101), such as name, address, and other demographic data.

In one embodiment, the loyalty program allows the user (101) to accumulate benefits according to loyalty program rules (185), such as reward points, cash back, levels of discounts, etc. For example, the user (101) may accumulate reward points for transactions that satisfy the loyalty program rules (185); and the user (101) may use the reward points to redeem cash, gift, discounts, etc. In one embodiment, the loyalty record (187) stores the accumulated benefits; and the transaction handler (103) updates the loyalty record (187) associated with the loyalty benefit offeror (183) and the account identifier (181), when events that satisfy the loyalty program rules occur.

In one embodiment, the accumulated benefits as indicated in the loyalty record (187) can be redeemed when the account identifier (181) is used to perform a payment transaction, when the payment transaction satisfies the loyalty program rules. For example, the user (101) may redeem a number of points to offset or reduce an amount of the purchase price.

In one embodiment, when the user (101) uses the account identifier (181) to make purchases as a member, the merchant may further provide information about the purchases; and the transaction handler (103) can store the information about the purchases as part of the loyalty record (187). The information about the purchases may identify specific items or services purchased by the member. For example, the merchant may provide the transaction handler (103) with purchase details at stock-keeping unit (SKU) level, which are then stored as part of the loyalty record (187). The loyalty benefit offeror (183) may use the purchase details to study the purchase behavior of the user (101); and the profile generator (121) may use the SKU level purchase details to enhance the transaction profiles (127).

In one embodiment, the SKU level purchase details are requested from the merchants or retailers via authorization responses (e.g., as illustrated in FIG. 9), when the account (146) of the user (101) is enrolled in a loyalty program that allows the transaction handler (103) (and/or the issuer processor (145)) to collect the purchase details.

A method to provide loyalty programs of one embodiment includes the use of the transaction handler (103) as part of a computing apparatus. The computing apparatus processes a plurality of payment card transactions. After the computing apparatus receives a request to track transactions for a loyalty program, such as the loyalty program rules (185), the computing apparatus stores and updates loyalty program information in response to transactions occurring in the loyalty program. The computing apparatus provides to a customer (e.g., 101) an offer of a benefit when the customer satisfies a condition defined in the loyalty program, such as the loyalty program rules (185). In one embodiment, the loyalty benefit as identified in the loyalty record (187) can be redeemed in connection with a transaction in a way the benefit of an offer stored in association with the account identifier (181) is redeemed.

Examples of loyalty programs through collaboration between collaborative constituents in a payment processing system, including the transaction handler (103) in one embodiment are provided in U.S. patent application Ser. No. 11/767,202, filed Jun. 22, 2007, assigned U.S. Pat. App. Pub. No. 2008/0059302, and entitled “Loyalty Program Service,” U.S. patent application Ser. No. 11/848,112, filed Aug. 30, 2007, assigned U.S. Pat. App. Pub. No. 2008/0059306, and entitled “Loyalty Program Incentive Determination,” and U.S. patent application Ser. No. 11/848,179, filed Aug. 30, 2007, assigned U.S. Pat. App. Pub. No. 2008/0059307, and entitled “Loyalty Program Parameter Collaboration,” the disclosures of which applications are hereby incorporated herein by reference.

Examples of processing the redemption of accumulated loyalty benefits via the transaction handler (103) in one embodiment are provided in U.S. patent application Ser. No. 11/835,100, filed Aug. 7, 2007, assigned U.S. Pat. App. Pub. No. 2008/0059303, and entitled “Transaction Evaluation for Providing Rewards,” the disclosure of which is hereby incorporated herein by reference.

In one embodiment, the incentive, reward, or benefit provided in the loyalty program is based on the presence of correlated related transactions. For example, in one embodiment, an incentive is provided if a financial payment card is used in a reservation system to make a reservation and the financial payment card is subsequently used to pay for the reserved good or service. Further details and examples of one embodiment are provided in U.S. patent application Ser. No. 11/945,907, filed Nov. 27, 2007, assigned U.S. Pat. App. Pub. No. 2008/0071587, and entitled “Incentive Wireless Communication Reservation,” the disclosure of which is hereby incorporated herein by reference.

In one embodiment, the transaction handler (103) provides centralized loyalty program management, reporting and membership services. In one embodiment, membership data is downloaded from the transaction handler (103) to acceptance point devices, such as the transaction terminal (105). In one embodiment, loyalty transactions are reported from the acceptance point devices to the transaction handler (103); and the data indicating the loyalty points, rewards, benefits, etc. are stored on the account identification device (141). Further details and examples of one embodiment are provided in U.S. patent application Ser. No. 10/401,504, filed Mar. 27, 2003, assigned U.S. Pat. App. Pub. No. 2004/0054581, and entitled “Network Centric Loyalty System,” the disclosure of which is hereby incorporated herein by reference.

In one embodiment, the portal (143) of the transaction handler (103) is used to manage reward or loyalty programs for entities such as issuers, merchants, etc. The cardholders, such as the user (101), are rewarded with offers/benefits from merchants. The portal (143) and/or the transaction handler (103) track the transaction records for the merchants for the reward or loyalty programs. Further details and examples of one embodiment are provided in U.S. patent application Ser. No. 11/688,423, filed Mar. 20, 2007, assigned U.S. Pat. App. Pub. No. 2008/0195473, and entitled “Reward Program Manager,” the disclosure of which is hereby incorporated herein by reference.

In one embodiment, a loyalty program includes multiple entities providing access to detailed transaction data, which allows the flexibility for the customization of the loyalty program. For example, issuers or merchants may sponsor the loyalty program to provide rewards; and the portal (143) and/or the transaction handler (103) stores the loyalty currency in the data warehouse (149). Further details and examples of one embodiment are provided in U.S. patent application Ser. No. 12/177,530, filed Jul. 22, 2008, assigned U.S. Pat. App. Pub. No. 2009/0030793, and entitled “Multi-Vender Multi-Loyalty Currency Program,” the disclosure of which is hereby incorporated herein by reference.

In one embodiment, an incentive program is created on the portal (143) of the transaction handler (103). The portal (143) collects offers from a plurality of merchants and stores the offers in the data warehouse (149). The offers may have associated criteria for their distributions. The portal (143) and/or the transaction handler (103) may recommend offers based on the transaction data (109). In one embodiment, the transaction handler (103) automatically applies the benefits of the offers during the processing of the transactions when the transactions satisfy the conditions associated with the offers. In one embodiment, the transaction handler (103) communicates with transaction terminals (105) to set up, customize, and/or update offers based on market focus, product categories, service categories, targeted consumer demographics, etc. Further details and examples of one embodiment are provided in U.S. patent application Ser. No. 12/413,097, filed Mar. 27, 2009, assigned U.S. Pat. App. Pub. No. 2010/0049620, and entitled “Merchant Device Support of an Integrated Offer Network,” the disclosure of which is hereby incorporated herein by reference.

In one embodiment, the transaction handler (103) is configured to provide offers from merchants to the user (101) via the payment system, making accessing and redeeming the offers convenient for the user (101). The offers may be triggered by and/or tailored to a previous transaction, and may be valid only for a limited period of time starting from the date of the previous transaction. If the transaction handler (103) determines that a subsequent transaction processed by the transaction handler (103) meets the conditions for the redemption of an offer, the transaction handler (103) may credit the consumer account (146) for the redemption of the offer and/or provide a notification message to the user (101). Further details and examples of one embodiment are provided in U.S. patent application Ser. No. 12/566,350, filed Sep. 24, 2009, assigned U.S. Pat. App. Pub. No. 2010/0114686, and entitled “Real-Time Statement Credits and Notifications,” the disclosure of which is hereby incorporated herein by reference.

Details on loyalty programs in one embodiment are provided in U.S. patent application Ser. No. 12/896,632, filed Oct. 1, 2010, assigned U.S. Pat. App. Pub. No. 2011/0087530, and entitled “Systems and Methods to Provide Loyalty Programs,” the disclosure of which is hereby incorporated herein by reference.

### SKU

In one embodiment, merchants generate stock-keeping unit (SKU) or other specific information that identifies the particular goods and services purchased by the user (101) or customer. The SKU information may be provided to the operator of the transaction handler (103) that processed the purchases. The operator of the transaction handler (103) may store the SKU information as part of transaction data (109), and reflect the SKU information for a particular transaction in a transaction profile (127 or 131) associated with the person involved in the transaction.

When a user (101) shops at a traditional retail store or browses a website of an online merchant, an SKU-level profile associated specifically with the user (101) may be provided to select an advertisement appropriately targeted to the user (101) (e.g., via mobile phones, POS terminals, web browsers, etc.). The SKU-level profile for the user (101) may include an identification of the goods and services historically purchased by the user (101). In addition, the SKU-level profile for the user (101) may identify goods and services that the user (101) may purchase in the future. The identification may be based on historical purchases reflected in SKU-level profiles of other individuals or groups that are determined to be similar to the user (101). Accordingly, the return on investment for advertisers and merchants can be greatly improved.

In one embodiment, the user specific profile (131) is an aggregated spending profile (341) that is generated using the SKU-level information. For example, in one embodiment, the factor values (344) correspond to factor definitions (331) that are generated based on aggregating spending in different categories of products and/or services. A typical merchant offers products and/or services in many different categories.

In one embodiment, the SKU level purchase details are requested from the merchants or retailers via authorization responses (e.g., as illustrated in FIG. 9), when the account (146) of the user (101) is enrolled in a program that allows the transaction handler (103) (and/or the issuer processor (145)) to collect the purchase details. Based on the SKU information and perhaps other transaction data, the profile generator (121) may create an SKU-level transaction profile for the user (101). In one embodiment, based on the SKU information associated with the transactions for each person entering into transactions with the operator of the transaction handler (103), the profile generator (121) may create an SKU-level transaction profile for each person.

Details on SKU-level profile in one embodiment are provided in U.S. patent application Ser. No. 12/899,144, filed Oct. 6, 2010, assigned U.S. Pat. App. Pub. No. 2011/0093335, and entitled “Systems and Methods for Advertising Services Based on an SKU-Level Profile,” the disclosure of which is hereby incorporated herein by reference.

### Purchase Details

In one embodiment, the transaction handler (103) is configured to selectively request purchase details via authorization responses. When the transaction handler (103) (and/or the issuer processor (145)) needs purchase details, such as identification of specific items purchased and/or their prices, the authorization responses transmitted from the transaction handler (103) is to include an indicator to request for the purchase details for the transaction that is being authorized. The merchants are to determine whether or not to submit purchase details based on whether or not there is a demand indicated in the authorization responses from the transaction handler (103).

FIG. 9 shows a system to obtain purchase details according to one embodiment. In FIG. 9, when the user (101) uses the consumer account (146) to make a payment for a purchase, the transaction terminal (105) of the merchant or retailer sends an authorization request (168) to the transaction handler (103). In response, an authorization response (138) is transmitted from the transaction handler (103) to the transaction terminal (105) to inform the merchant or retailer of the decision to approve or reject the payment request, as decided by the issuer processor (145) and/or the transaction handler (103). The authorization response (138) typically includes an authorization code (137) to identify the transaction and/or to signal that the transaction is approved.

In one embodiment, when the transaction is approved and there is a need for purchase details (169), the transaction handler (103) (or the issuer processor (145)) is to provide an indicator of the request (139) for purchase details in the authorization response (138). The optional request (139) allows the transaction handler (103) (and/or the issuer processor (145)) to request purchase details (169) from the merchant or retailer on demand. When the request (139) for purchase details is present in the authorization response (138), the transaction terminal (105) is to provide the purchase details (169) associated with the payment transaction to the transaction handler (103) directly or indirectly via the portal (143). When the request (139) is absent from the authorization response (138), the transaction terminal (105) does not have to provide the purchase details (169) for the payment transaction.

In one embodiment, prior to transmitting the authorization response (138), the transaction handler (103) (and/or the issuer processor (145)) determines whether there is a need for transaction details. When there is no need for the purchase details (169) for a payment transaction, the request (139) for purchase details (169) is not provided in the authorization response (138) for the payment transaction. When there is a need for the purchase details (169) for a payment transaction, the request (139) for purchase details is provided in the authorization response (138) for the payment transaction. The merchants or retailers do not have to send detailed purchase data to the transaction handler (103) when the authorization response message does not explicitly request detailed purchase data.

### Cookie to Account

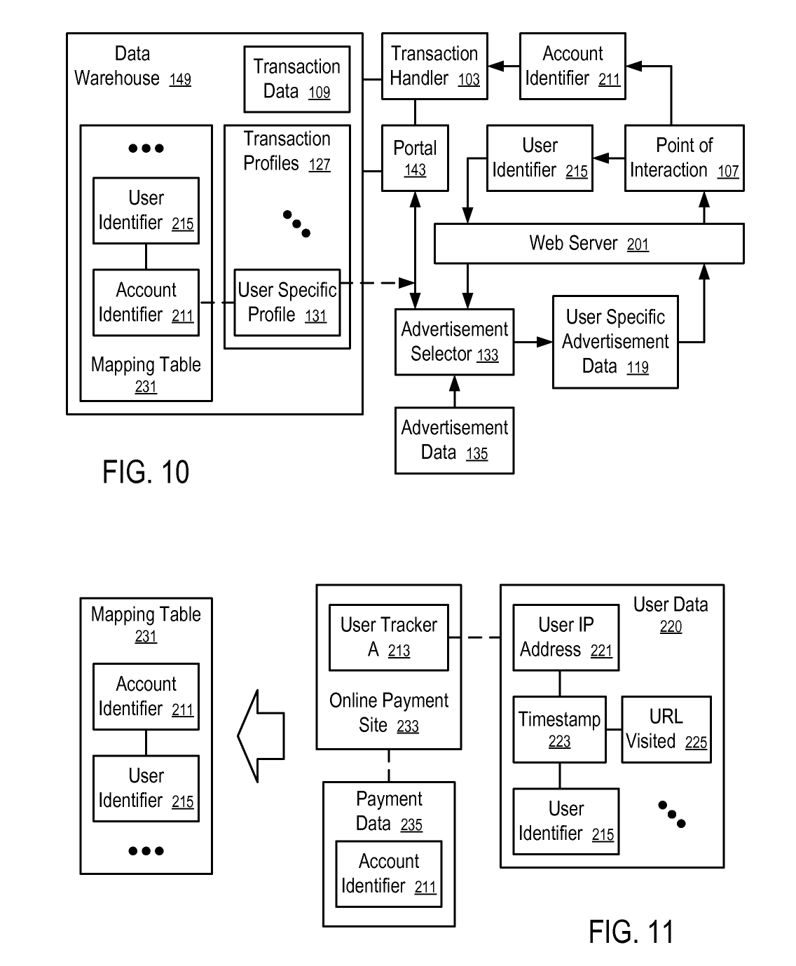

FIG. 10 shows a system to target advertisements according to one embodiment. In FIG. 10, the user (101) is to use the point of interaction (107) to access the web server (201). The web server (201) uses the user identifier (215) to track the online activities of the user (101). The user (101) is to use the account identifier (211) on the point of interaction (107) to make online purchases. The transaction handler (103) is to process payments in response to online payment requests that identify the account identifier (211), which may be submitted from the point of interaction (107) to the transaction handler (103) via a number of entities, such as the merchant website, a web server configured to manage online payments on behalf of different merchants, and/or acquirer processors (e.g., 147). The user (101) may also use other transaction terminals (e.g. 105) to make payments offline in retail stores, to make payments via phone, or via different points of interaction (107) for online purchases. The transaction handler (103) is to record information about the payments made via the account identifier (211) as part of the transaction data (109). The profile generator (121) is to generate the transaction profiles (127) of different users from the transaction data (109) recorded by the transaction handler (103).

In FIG. 10, the data warehouse (149) associated with the transaction handler (103) is to store a mapping table (231) that maps the user identifier (215) to the account identifier (211). To target the user identified by the user identifier (215), the advertisement selector (133) is to use the user identifier (215) to query the portal (143) for transaction-based intelligence information, such as the user specific profile (131) of the user (101), or portions of the transaction data (109) of the user (101). In response to the query that identifies the user identifier (215) used by the web server (201) to track the online activity of the user (101), the portal (143) is to use the mapping table (231) to determine the account identifier (211) from the user identifier (215) and then identify the user specific profile (131) associated with the account identifier (211) of the user (101).

In one embodiment, the portal (143) is to provide the user specific profile (131) to the advertisement selector (133), as a response to the query, to allow the advertisement selector (133) to identify the user specific advertisement data (119) based on a database of advertisement data (135). In one embodiment, the advertiser selector (133) is to identify, generate, select, prioritize, adjust, personalize, and/or target the user specific advertisement data (119) based on the user specific profile (131). The web server (201) is to provide the user specific advertisement data (119) to the user (101) at the point of interaction (107) via the web server (201).

In one embodiment, the portal (143) is to provide part of the transaction data (109) of the user (101) relevant to the query to the advertisement selector (133) for the identification, generation, selection, prioritization, adjustment, personalization, and/or customization of the user specific advertisement data (119).

In one embodiment, the advertisement is presented according to the user specific advertisement data (119) in a web page of the web server (201). For example, when the web server (201) provides the services of a search engine, the advertisement can be presented with search results.

In one embodiment, the web sever (201) is to present the advertisement in web pages of other websites. For example, the websites of a blog, an online marketplace, an online newspaper, etc., may include a reference to the web server (201) for the placement of advertisements within the web pages of their websites. In such an arrangement, the user identifier (215) can be used by the web server (201), such as the server of an advertisement network, to track online activities across different websites operated by different entities. The user identifier (215) can be used to identify the user (101) in websites where the user (101) has not used the account identifier (211) to make purchases. When the user identifier (215) is mapped to account identifier (211) to identify the user (101), the user specific advertisement data (119) can be targeted at the user (101) using the intelligence information afforded by the transaction data (109) associated with the account identifier (211) even when the user (101) is outside the context of online payment and browsing as an anonymous Internet user.

In one embodiment, the user identifier (215) is used by the web server (201) to track anonymous users without requiring the user (101) to register. For example, in one embodiment, the web server (201) is to use a browser cookie to identify the user (101). When the browser of the user (101) first visits the web server (201), the web server (201) assigns the user identifier (215) to the browser of the user (101); and the browser of the user (101) stores the user identifier (215) in a browser cookie associated with the web server (201). When the browser of the user (101) subsequently revisits the web server (201), the browser of the user (101) is to provide the user identifier (215) back to the web server (201) and thus identify the user (101) via the user identifier (215).

In some embodiments, the web server (201) may register the user (101) to obtain further information about the user (101). The registration information can also be used to link the user identifier (215) to the account identifier (211) of the user (101).

In one embodiment, after the presentation of an advertisement based on the user specific advertisement data (119) (or another advertisement delivered without the use of the user specific profile (131) or related transaction data (109)), the web server (201) or the advertisement selector (133) may query the portal (143) using the user identifier (215) to determine purchase information related to the advertisement.

For example, the query may request information on whether the user (101) as identified by the user identifier (215) has made the purchase according to the advertisement, or made a related purchase. The portal (143) is to use mapping table (231) to determine the account identifier (211) of the user (101) corresponding to the user identifier (215) and to search for related transaction information requested in the query. The related transaction information can be used to assess the effectiveness of the advertisement. For example, in some embodiments, the user (101) may make an offline purchase after receiving the online advertisement from the web server (201); and the related transaction information can correlate the online advertisement to the offline purchase. Details about correlating purchase transactions and online activities that lead to the transactions in one embodiment are provided in the section entitled “CLOSE THE LOOP.”

In one embodiment, the association relationship between the user identifier (215) and the account identifier (211) is based on the same web server (201) that observes the user identifier (215) and the account identifier (211) in a same web communication, as illustrated in FIG. 11.

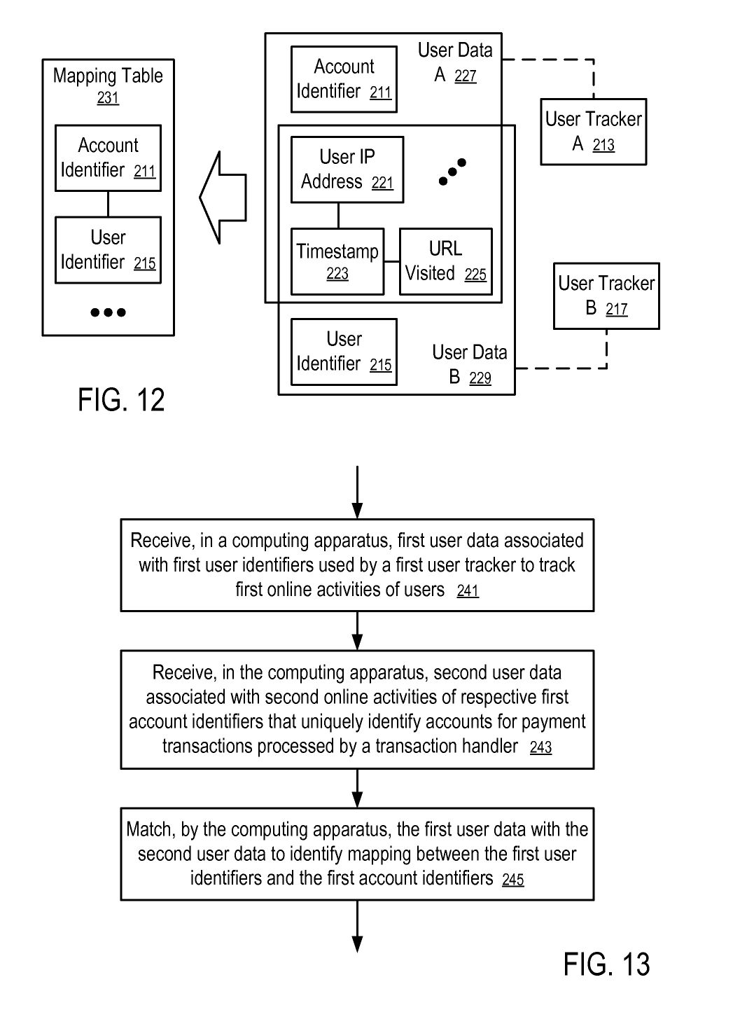

In one embodiment, the association relationship between the user identifier (215) and the account identifier (211) is based on correlating the user data (125) tracked by the user trackers (e.g., 113) of different web servers (201) which separately observe the user identifier (215) and the account identifier (211) in separate communications, as illustrated in FIG. 12.

FIGS. 11-12 illustrate systems to map user identifiers to account identifiers according to some embodiments.

In FIG. 11, a user tracker A (213) is used by an online payment site (233), or other websites that have access to the account identifier (211), such as an online merchant site that registers users and their account identifiers (e.g., 211), or the portal (143) that is to verify the passwords of the users for their uses of the account identifiers in making online payments. The user tracker A (213) is to identify the online user (101) and generate the user data (220) that can be used by the online payment site (233) to identify the online user (101). In one embodiment, the user tracker A (213) is to link multiple Hypertext Transfer Protocol (HTTP) requests to an identity of an online user (101), when the online activities of the user (101) include HTTP requests to view web pages in a web browser and the web pages include components (e.g., an advertisement, a single-pixel image, a script) that reside on the online payment site (233).

In one embodiment, an Internet Protocol (IP) address (221) of the requester may be used to temporarily identify the online user (101). For example, it may be assumed that for a period of time, the IP address (221) of the user (101) does not change and thus can be used as an identifier of the user (101). However, the IP address (221) of the user (101) typically changes from time to time; and it is desirable to track the user (101) even when the IP address (221) of the user (101) changes, so that activities of the user (101) at different IP addresses (e.g., 221) with different timestamps (e.g., 223) can be linked to the same online user (101), which may be an anonymous user, or a registered user.

To better track the user (101), the online payment site (233) is to provide the web browser of the user (101) with a piece of information to uniquely represent the user (101). The piece of information is provided to the web browser during one visit to the online payment site (233); and the web browser is configured to provide the piece of information back to the online payment site (233) during subsequent visits to the online payment site (233). The piece of information may be used as the user identifier (215) to identify the user (101). The mechanism to communicate this piece of information can be implemented via a browser cookie, or other techniques, such as parameters embedded in a Uniform Resource Locator (URL), hidden form fields in a web page, etc. Thus, the user identifier (215) can link the online activities of the user (101) across multiple user IP addresses (e.g., 221).

In one embodiment, a browser cookie is the piece of information provided by a web server (e.g., 201) to a web browser; and the web browser is configured to provide the piece of information back to the web server (e.g., 201) when the web browser subsequently visits the web server (e.g., 201) again for the same web page or different web pages. In one embodiment, the web browser (e.g., 201) does not present the piece of information as a visible part of a web page; and this piece of information is not considered a part of the source code of the web page and is not normally displayed to the user (101). The user identifier (215) assigned and/or tracked using the browser cookie mechanism can be referred to as the cookie ID of the user (101).

In one embodiment, while the user (101) is tracked via the user identifier (215), if the user (101) provides the account identifier (211), such as the account number (302) of a financial transaction card (or the account information (142)), as part of payment data (235) to the online payment site (233) for a purchase (or during other occasions, such as user registration), the online payment site (233) can associate the account identifier (211) with the user identifier (215) and other portions of the user data (220), such as the IP address (221) of the user (101) used at a time indicated by the timestamp (223) of the visit to the URL (225). The URL (225) may be the address of the web page on the online payment site (233), or a web page of a merchant that refers the user (101) to the online payment site (233).

In one embodiment, the online payment site (233) is to link the account identifier (211) and the user identifier (215) in a mapping table (231) to subsequently map the user identifier (215) to the account identifier (211) and use the account identifier (211) as the user data (125) in the system of FIG. 1 to select or identify the user specific profile (131) and/or to query for other information, such as transaction data (109) related to the user specific advertisement data (119).

In one embodiment, the online payment site (233) is operated by an entity operating the transaction handler (103). In another embodiment, the online payment site (233) is operated by an entity different from the entity operating the transaction handler (103).

In one embodiment, user data from different user trackers are matched to link the account identifier (211) known to one user tracker A (213), to the user identifier (215) used independently by another user tracker B (217) to track user online activities, as illustrated in FIG. 12.

In one embodiment of FIG. 12, the user tracker B (217) has no access to the account identifier (211). For example, the user tracker B (217) may be used by an advertisement provider to place advertisements; and a typical user would not submit the account identifier (211) to the advertisement provider. As an advertisement provider, the user tracker B (217) can observe the URLs of the web pages in which the advertisements are presented. The user tracker B (217) may or may not have access to the content of the web pages in which the advertisements are presented, since access to some of the web pages may require user authentication.

In FIG. 12, the common portions of the user data (227) from the user tracker A (213) and the user data (229) from the user tracker B (217) are correlated to link the account identifier (211) and the user identifier (215).

For example, when the user data (227 and 229) show common user activities at the same user IP address (221) at the same timestamp (223) (or timestamps that are close in time), the user data (227 and 229) can be linked to the same user and thus allow the association between the account identifier (211), known to the user tracker A (213), and the user identifier (215) used by another user tracker B (217). The association relationship between the account identifier (211) known to the user tracker A (213) and the user identifier (215) used by another user tracker B (217) can be stored in the mapping table (231) to allow mapping from the user identifier (215) to the account identifier (211) to query an entity operating the transaction handler (103) for transaction data (109) specific to the account identifier (211), or to select the user specific profile (131).

In one embodiment, the user tracker B (217) provides the user data (229) to the user tracker A (213) to allow the user tracker A (213) to correlate the user data (227 and 229) and generate the mapping table (231). In another embodiment, both the user tracker A (213) and the user tracker B (217) provide the user data (227 and 229) to a separate correlator, which may be under control of the entity operating the transaction handler (103) or a different entity. The correlator generates the mapping table (231) and provides the services for the transaction handler (103) (and/or the profile selector (129)) to look up the account identifier (211) based on the user identifier (215).

In one embodiment, to improve security, the account identifier (211) may not be the original account number of the financial transaction card of the user (101). For example, in one embodiment, the account identifier (211) is a hash of the original account number or an encoded or encrypted version of the original account number. Different account numbers are hashed, encoded, or encrypted to generate different account identifiers (e.g., 211). However, to protect the original account number, it is generally difficult to determine the original account number from the account identifier (211) (e.g., without the knowledge of the encoding scheme, the decryption key, etc.). Any known techniques for hashing, encoding and/or encrypting the account number can be used.

In one embodiment, the system does not rely upon the user trackers (213 and 217) to observe the same activity to correlate the user data (227 and 229). For example, the user (101) may visit two web pages tracked separately by the user trackers (213 and 217). Although the timestamps of the IP address for accessing the two web pages may not be the same, the close proximity of the timestamps link the IP address to the same user (101). For example, when the timestamp of an activity observed by the user tracker A (213) is between two timestamps of activities observed by the user tracker B (217) at the same IP address (221), these observed activities can be linked to the same user (101).

Further, the correlation of the URLs (e.g., 225) can be an indication of the same user (101). For example, the referral URL observed by the user tracker A (213) may match the referral URL observed by the user tracker B (217), which is an indication of the same user (101).

In some embodiments, a match between two online activities as represented by the user data (227 and 229) indicates a link between the account identifier (211) and the user identifier (215) with certain probability. When there are a large number of matches, the probability of the link between the account identifier (211) and the user identifier (215) increases. When the probability is above a threshold (e.g., when the number of matches is above a threshold), the match between the account identifier (211) and the user identifier (215) can be recorded in the mapping table (231).

In some embodiments, the user tracker A (213) and the user tracker B (217) may observe the same user activity to correlate the account identifier (211) and the user identifier (215). For example, the user tracker A (213) may be used by an online payment site (233) and the user tracker B (217) may be used by an advertisement provider. When the user (101) visits an online payment site (233), the online payment site (233) provides the user identifier (215) used by the user tracker A (213) to the user tracker B (217) (e.g., via parameters embedded in a URL, form parameters, API, etc.) to allow the user tracker B (217) to correlate the user identifier (215) used by the user tracker A (213) with the user identifier (215) used by the user tracker B (217). Subsequently, the user identifier (215) can be used to map the account identifier (211) with the user identifier (215) of the user tracker B (217).

Similarly, when an advertisement is presented on the web page on the online payment site (233), the user tracker B (217) may provide the user identifier (215) to the user tracker A (213) via a reference from the advertisement to an element on the online payment site (233) (e.g., via parameters embedded in a URL, form parameters, API, etc.). Thus, the user tracker A (213) can correlate the user identifier (215) used by the user tracker B (217) with the user identifier (215) used by the user tracker A (213), and thus to the account identifier (211).

When the user identifier (215) used by the user tracker B (217) to track anonymous user online behavior is mapped to the account identifier (211), the account identifier (211) can be used to obtain intelligence information about the user (101) for advertising, based on the transaction data (109).

For example, an advertisement provider using the user tracker B (217) may send an inquiry to a profile provider (e.g., profile selector (129)) to obtain information specific to the user (101) having the account identifier (211), such as the percentage of the user's total spending for a given merchant category, the segment of users to which the user (101) belongs, etc.

For example, an online merchant may use the account identifier (211) to query for transaction data related to an advertisement. The transaction handler (103) may provide transaction data (109) specific to the user (101) having the account identifier (211) to the merchant to match the online activities of the user (101) at the online merchant with purchase transactions. For example, the online merchant may specify an advertisement category and a date of the advertisement; and in response, a web portal (e.g., 143) of the transaction handler (103) may provide information on one or more transactions in the category, indicating the date and amount of the transactions, the location and the identity of the merchants for the corresponding transactions, etc.

FIG. 13 shows a method to map user identifiers to account identifiers according to some embodiments. In FIG. 13, a computing apparatus receives (241) first user data (e.g., 229) associated with first user identifiers (e.g., 215) used by a first user tracker (217) to track first online activities of users and receives (243) second user data (e.g., 227) associated with second online activities of respective first account identifiers (e.g., 211) that uniquely identify accounts for payment transactions processed by a transaction handler (103). The computing apparatus matches (245) the first user data (e.g., 229) with the second user data (e.g., 227) to identify mapping (e.g., 231) between the first user identifiers (e.g., 215) and the first account identifiers (e.g., 211).

In one embodiment, the computing apparatus includes at least one of: a data warehouse (149), a portal (143), an advertisement selector (133), a transaction handler (103), a profile generator (121), a web server (201), and a correlator.

In one embodiment, the first user identifiers (e.g., 215) are browser cookie based identifiers; and the first account identifiers are account numbers (e.g., 302) of financial transaction cards. Details about the use of a browser cookie in one embodiment are provided in the section entitled “BROWSER COOKIE.”

In one embodiment, the computing apparatus of the transaction handler (103) stores transaction data (109) related to a plurality of transactions processed at the transaction handler (103), receives a second user identifier (215) used by the first tracker (217) to track online activities of a user (101), identifies a second account identifier (211) of the user (101) based on the mapping (e.g., 231), and provides transaction information based at least in part on a portion of the transaction data (109) associated with the second account identifier (211).

In one embodiment, the transaction information provided by the computing apparatus of the transaction handler (103) is used to identify a personalized or targeted advertisement for the user (101), or to correlate with online activities via identifying one or more purchases related to an advertisement presented to the user (101) as identified by the second user identifier (211).

In one embodiment, the first user tracker (217) and the second user tracker (213) are operated by different web servers; the first user data (229) and the second user data (227) have a plurality of common data fields (e.g., 221-225); and the marching is based on the common data fields (e.g., 221-225), such as timestamp (223), and Internet Protocol (IP) address (221).

In one embodiment, the second user tracker (213) is used on a website of the transaction handler (103) to verify passwords to use the first account identifiers (e.g., 211) for online transactions, or a web server (e.g., 201) managing electronic payments for different merchants.

In one embodiment, the computing apparatus is to store transaction data (109) related to a plurality of transactions processed at the transaction handler (103). Each of the plurality of transactions is processed to make a payment from an issuer to an acquirer via the transaction handler (103) in response to an account identifier (211) of a customer, as issued by the issuer, being submitted by a merchant to the acquirer. The issuer is to make the payment on behalf of the customer, and the acquirer is to receive the payment on behalf of the merchant. Details about the transaction handler (103) and the portal (143) in one embodiment are provided in the section entitled “TRANSACTION DATA BASED PORTAL.”

In one embodiment, the advertisement identified using the transaction information (109) includes at least an offer identified based on the transaction information (109), such as a discount, incentive, reward, coupon, gift, cash back, benefit, product, and service. Details about targeting advertisement in one embodiment are provided in the section entitled “TARGETING ADVERTISEMENT.”

In one embodiment, the advertisement is presented on a point of interaction (107) in a context outside any transaction processed by the transaction handler (103). Details about the point of interaction in one embodiment are provided in the section entitled “POINT OF INTERACTION.”

In one embodiment, in response to a user selection of the advertisement, the offer provided in the advertisement is stored in the data warehouse (149) in association with the consumer account (146) of the user (101); and the transaction handler (103) can automatically redeem the offer for the user (101) when a purchase satisfying the redemption requirements of the offer occurs (or download the offer as a coupon to a mobile phone of the user (101) for redemption at the time of the purchase paid via the account identifier (211)). Details about offer redemption in some embodiments are provided in the section entitled “PURCHASE DETAILS” and the section entitled “ON ATM & POS TERMINAL.”

In one embodiment, the first tracker (217) is operated by a web server (201) to track the user (101) as an anonymous user; and the web server (201) is to deliver advertisements in the web pages of a plurality of different websites operated by different entities.

In one embodiment, the transaction information includes a profile (e.g., 131 or 341) summarizing transaction data (109) of the user (101) using a plurality of values (e.g., 343, 344, 346) representing aggregated spending in various areas; and the values (e.g., 343, 344, 346) are computed based on factor definitions (331) identified from a factor analysis (327) of a plurality of variables (e.g., 311, 313, 315). In one embodiment, the factor analysis (327) is based on transaction data (109) associated with a plurality of users; and the variables (e.g., 311, 313, 315) aggregate the transactions based on merchant categories (e.g. 306). In one embodiment, the variables (e.g., 311, 313, 315) include spending frequency variables (313) and spending amount variables (315).

In one embodiment, the computing apparatus is to generate the profile (e.g., 131 or 341) using the transaction data (109) of the user (101) based on cluster definitions (333) and factor definitions (331); and the cluster definitions (333) and factor definitions (331) are generated based on transaction data (109) of a plurality of users, such as transaction records (301) recorded by the transaction handler (103). Details about the profile (e.g., 133 or 341) in one embodiment are provided in the section entitled “TRANSACTION PROFILE” and the section entitled “AGGREGATED SPENDING PROFILE.”

Details about the system in one embodiment are provided in the sections entitled “SYSTEM,” “CENTRALIZED DATA WAREHOUSE” and “HARDWARE.”

### Variations

Some embodiments use more or fewer components than those illustrated in the figures.

In one embodiment, at least some of the profile generator (121), correlator (117), profile selector (129), and advertisement selector (133) are controlled by the entity that operates the transaction handler (103). In another embodiment, at least some of the profile generator (121), correlator (117), profile selector (129), and advertisement selector (133) are not controlled by the entity that operates the transaction handler (103).

In one embodiment, the products and/or services purchased by the user (101) are also identified by the information transmitted from the merchants or service providers. Thus, the transaction data (109) may include identification of the individual products and/or services, which allows the profile generator (121) to generate transaction profiles (127) with fine granularity or resolution. In one embodiment, the granularity or resolution may be at a level of distinct products and services that can be purchased (e.g., stock-keeping unit (SKU) level), or category or type of products or services, or vendor of products or services, etc.

In one embodiment, the entity operating the transaction handler (103) provides the intelligence information in real time as the request for the intelligence information occurs. In other embodiments, the entity operating the transaction handler (103) may provide the intelligence information in batch mode. The intelligence information can be delivered via online communications (e.g., via an application programming interface (API) on a website, or other information server), or via physical transportation of a computer readable media that stores the data representing the intelligence information.

In one embodiment, the intelligence information is communicated to various entities in the system in a way similar to, and/or in parallel with the information flow in the transaction system to move money. The transaction handler (103) routes the information in the same way it routes the currency involved in the transactions.

In one embodiment, the portal (143) provides a user interface to allow the user (101) to select items offered on different merchant websites and store the selected items in a wish list for comparison, reviewing, purchasing, tracking, etc. The information collected via the wish list can be used to improve the transaction profiles (127) and derive intelligence on the needs of the user (101); and targeted advertisements can be delivered to the user (101) via the wish list user interface provided by the portal (143). Examples of user interface systems to manage wish lists are provided in U.S. patent application Ser. No. 12/683,802, filed Jan. 7, 2010, assigned U.S. Pat. App. Pub. No. 2010/0174623, and entitled “System and Method for Managing Items of Interest Selected from Online Merchants,” the disclosure of which is hereby incorporated herein by reference.

### Aggregated Spending Profile

In one embodiment, the characteristics of transaction patterns of customers are profiled via clusters, factors, and/or categories of purchases. The transaction data (109) may include transaction records (301); and in one embodiment, an aggregated spending profile (341) is generated from the transaction records (301), in a way illustrated in FIG. 2, to summarize the spending behavior reflected in the transaction records (301).

In FIG. 2, each of the transaction records (301) is for a particular transaction processed by the transaction handler (103). Each of the transaction records (301) provides information about the particular transaction, such as the account number (302) of the consumer account (146) used to pay for the purchase, the date (303) (and/or time) of the transaction, the amount (304) of the transaction, the ID (305) of the merchant who receives the payment, the category (306) of the merchant, the channel (307) through which the purchase was made, etc. Examples of channels include online, offline in-store, via phone, etc. In one embodiment, the transaction records (301) may further include a field to identify a type of transaction, such as card-present, card-not-present, etc.

A “card-present” transaction typically involves physically presenting the account identification device (141), such as a financial transaction card, to the merchant (e.g., via swiping a credit card at a POS terminal of a merchant); and a “card-not-present” transaction typically involves presenting the account information (142) of the consumer account (146) to the merchant to identify the consumer account (146) without physically presenting the account identification device (141) to the merchant or the transaction terminal (105).

The transaction records (301) of one embodiment may further include details about the products and/or services involved in the purchase.

When there is voluminous data representing the transaction records (301), the spending patterns reflected in the transaction records (301) can be difficult to recognize by an ordinary person.

In FIG. 2, the voluminous transaction records (301) are summarized (335) into aggregated spending profiles (e.g., 341) to concisely present the statistical spending characteristics reflected in the transaction records (301). The aggregated spending profile (341) uses values derived from statistical analysis to present the statistical characteristics of transaction records (301) of an entity in a way easy to understand by an ordinary person.

In FIG. 2, the transaction records (301) are summarized (335) via factor analysis (327) to condense the variables (e.g., 313, 315) and via cluster analysis (329) to segregate entities by spending patterns.

In FIG. 2, a set of variables (e.g., 311, 313, 315) are defined based on the parameters recorded in the transaction records (301). The variables (e.g., 311, 313, and 315) are defined in a way to have meanings easily understood by an ordinary person. For example, variables (311) measure the aggregated spending in super categories; variables (313) measure the spending frequencies in various areas; and variables (315) measure the spending amounts in various areas. In one embodiment, each of the areas is identified by a merchant category (306) (e.g., as represented by a merchant category code (MCC), a North American Industry Classification System (NAILS) code, or a similarly standardized category code). In other embodiments, an area may be identified by a product category, a SKU number, etc.

Examples of the spending frequency variables (313) and spending amount variables (315) defined for various merchant categories (e.g., 306) in one embodiment are provided in U.S. patent application Ser. No. 12/537,566, filed Aug. 7, 2009, assigned U.S. Pat. App. Pub. No. 2010/0306029, and entitled “Cardholder Clusters,” and in U.S. patent application Ser. No. 12/777,173, filed May 10, 2010, assigned U.S. Pat. App. Pub. No. 2010/0306032, and entitled “Systems and Methods to Summarize Transaction Data,” the disclosures of which applications are hereby incorporated herein by reference.

In FIG. 2, the aggregation (317) includes the application of the definitions (309) for these variables (e.g., 311, 313, and 315) to the transaction records (301) to generate the variable values (321). The transaction records (301) are aggregated to generate aggregated measurements (e.g., variable values (321)) that are not specific to a particular transaction, such as frequencies of purchases made with different merchants or different groups of merchants, the amounts spent with different merchants or different groups of merchants, and the number of unique purchases across different merchants or different groups of merchants, etc. The aggregation (317) can be performed for a particular time period and for entities at various levels.

The transaction records (301) can be aggregated according to a buying entity, or a selling entity. For example, the aggregation (317) can be performed at account level, person level, family level, company level, neighborhood level, city level, region level, etc. to analyze the spending patterns across various areas (e.g., sellers, products or services) for the respective aggregated buying entity. For example, the transaction records (301) for a particular merchant having transactions with multiple accounts can be aggregated for a merchant level analysis. For example, the transaction records (301) for a particular merchant group can be aggregated for a merchant group level analysis. The aggregation (317) can be formed separately for different types of transactions, such as transactions made online, offline, via phone, and/or “card-present” transactions vs. “card-not-present” transactions, which can be used to identify the spending pattern differences among different types of transactions.

In FIG. 2, the variable values (e.g., 323, 324, . . . , 325) associated with an entity ID (322) are considered the random samples of the respective variables (e.g., 311, 313, 315), sampled for the instance of an entity represented by the entity ID (322). Statistical analyses (e.g., factor analysis (327) and cluster analysis (329)) are performed to identify the patterns and correlations in the random samples.

Once the cluster definitions (333) are obtained from the cluster analysis (329), the identity of the cluster (e.g., cluster ID (343)) that contains the entity ID (322) can be used to characterize spending behavior of the entity represented by the entity ID (322). The entities in the same cluster are considered to have similar spending behaviors.

In FIG. 2, the random variables (e.g., 313 and 315) as defined by the definitions (309) have certain degrees of correlation and are not independent from each other. For example, merchants of different merchant categories (e.g., 306) may have overlapping business, or have certain business relationships. For example, certain products and/or services of certain merchants have cause and effect relationships. For example, certain products and/or services of certain merchants are mutually exclusive to a certain degree (e.g., a purchase from one merchant may have a level of probability to exclude the user (101) from making a purchase from another merchant). Such relationships may be complex and difficult to quantify by merely inspecting the categories. Further, such relationships may shift over time as the economy changes.

In FIG. 2, a factor analysis (327) is performed to reduce the redundancy and/or correlation among the variables (e.g., 313, 315). The factor analysis (327) identifies the definitions (331) for factors, each of which represents a combination of the variables (e.g., 313, 315). A factor from the factor analysis (327) is a linear combination of a plurality of the aggregated measurements (e.g., variables (313, 315)) determined for various areas (e.g., merchants or merchant categories, products or product categories). Once the relationship between the factors and the aggregated measurements is determined via factor analysis, the values for the factors can be determined from the linear combinations of the aggregated measurements and be used in a transaction profile (127 or 341) to provide information on the behavior of the entity represented by the entity ID (e.g., an account, an individual, a family).

Once the factor definitions (331) are obtained from the factor analysis (327), the factor definitions (331) can be applied to the variable values (321) to determine factor values (344) for the aggregated spending profile (341). Since redundancy and correlation are reduced in the factors, the number of factors is typically much smaller than the number of the original variables (e.g., 313, 315). Thus, the factor values (344) represent the concise summary of the original variables (e.g., 313, 315).

For example, there may be thousands of variables on spending frequency and amount for different merchant categories; and the factor analysis (327) can reduce the factor number to less than one hundred (and even less than twenty). In one example, a twelve-factor solution is obtained, which allows the use of twelve factors to combine the thousands of the original variables (313, 315); and thus, the spending behavior in thousands of merchant categories can be summarized via twelve factor values (344). In one embodiment, each factor is combination of at least four variables; and a typical variable has contributions to more than one factor.

In FIG. 2, an aggregated spending profile (341) for an entity represented by an entity ID (e.g., 322) includes the cluster ID (343) and factor values (344) determined based on the cluster definitions (333) and the factor definitions (331). The aggregated spending profile (341) may further include other statistical parameters, such as diversity index (342), channel distribution (345), category distribution (346), zip code (347), etc., as further discussed below.

In general, an aggregated spending profile (341) may include more or fewer fields than those illustrated in FIG. 2. For example, in one embodiment, the aggregated spending profile (341) further includes an aggregated spending amount for a period of time (e.g., the past twelve months); in another embodiment, the aggregated spending profile (341) does not include the category distribution (346); and in a further embodiment, the aggregated spending profile (341) may include a set of distance measures to the centroids of the clusters.

FIG. 3 shows a method to generate an aggregated spending profile according to one embodiment. In FIG. 3, computation models are established (351) for variables (e.g., 311, 313, and 315). In one embodiment, the variables are defined in a way to capture certain aspects of the spending statistics, such as frequency, amount, etc.

In FIG. 3, data from related accounts are combined (353); recurrent/installment transactions are combined (355); and account data are selected (357) according to a set of criteria related to activity, consistency, diversity, etc.

In FIG. 3, the computation models (e.g., as represented by the variable definitions (309)) are applied (359) to the remaining account data (e.g., transaction records (301)) to obtain data samples for the variables. The data points associated with the entities, other than those whose transactions fail to meet the minimum requirements for activity, consistency, diversity, etc., are used in factor analysis (327) and cluster analysis (329).

In FIG. 3, the data samples (e.g., variable values (321)) are used to perform (361) factor analysis (327) to identify factor solutions (e.g., factor definitions (331)). The factor solutions can be adjusted (363) to improve similarity in factor values of different sets of transaction data (109).

The data samples can also be used to perform (365) cluster analysis (329) to identify cluster solutions (e.g., cluster definitions (333)). The cluster solutions can be adjusted (367) to improve similarity in cluster identifications based on different sets of transaction data (109). For example, cluster definitions (333) can be applied to the transactions in the time period under analysis (e.g., the past twelve months) and be applied separately to the transactions in a prior time period (e.g., the twelve months before the past twelve months) to obtain two sets of cluster identifications for various entities. The cluster definitions (333) can be adjusted to improve the correlation between the two set of cluster identifications.

Optionally, human understandable characteristics of the factors and clusters are identified (369) to name the factors and clusters. For example, when the spending behavior of a cluster appears to be the behavior of an internet loyalist, the cluster can be named “internet loyalist” such that if a cardholder is found to be in the “internet loyalist” cluster, the spending preferences and patterns of the cardholder can be easily perceived.

In one embodiment, the factor analysis (327) and the cluster analysis (329) are performed periodically (e.g., once a year, or six months) to update the factor definitions (331) and the cluster definitions (333), which may change as the economy and the society change over time.

In FIG. 3, transaction data (109) are summarized (371) using the factor solutions and cluster solutions to generate the aggregated spending profile (341). The aggregated spending profile (341) can be updated more frequently than the factor solutions and cluster solutions, when the new transaction data (109) becomes available. For example, the aggregated spending profile (341) may be updated quarterly or monthly.

Details about aggregated spending profile (341) in one embodiment are provided in U.S. patent application Ser. No. 12/777,173, filed May 10, 2010, assigned U.S. Pat. App. Pub. No. 2010/0306032, and entitled “Systems and Methods to Summarize Transaction Data,” the disclosure of which is hereby incorporated herein by reference.

In one embodiment, a set of profiles are generated from the transaction data for a plurality of geographical regions, such as mutually exclusive, non-overlapping regions defined by postal codes. Transactions of account holders residing in the regions are aggregated according to merchant categories for the respective regions and subsequently normalized to obtain preference indicators that reveal the spending preferences of the account holders in the respective regions. Each of the profiles for respective regions is based on a plurality of different account holders and/or households to avoid revealing private information about individual account holders or families. Further, the profiles are constructed in a way to make it impossible to reverse calculate the transaction amounts. Further details and examples about profiles constructed for regions in one embodiment are provided in U.S. patent application Ser. No. 13/675,301, filed Nov. 13, 2012 and entitled “Systems and Methods to Summarize Transaction data,” the disclosure of which is hereby incorporated herein by reference.

### Transaction Processing and Data

FIG. 4 shows a system to provide information and/or services based on transaction data (109) according to one embodiment.

In FIG. 4, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records (301), such as the transaction profiles (127), aggregated spending profile (341), offer redemption notification, etc. The portal (143) may be implemented as a web portal, a telephone gateway, a file/data server, etc.

In FIG. 4, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 4, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 4, the transaction handler (103) uses the data warehouse (149) to store the records about the transactions, such as the transaction records (301) or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 4, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 4, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

In one embodiment, the portal (143) provides a user interface to allow the user (101) to organize the transactions in one or more consumer accounts (146) of the user with one or more issuers. The user (101) may organize the transactions using information and/or categories identified in the transaction records (301), such as merchant category (306), transaction date (303), amount (304), etc. Examples and techniques in one embodiment are provided in U.S. patent application Ser. No. 11/378,215, filed Mar. 16, 2006, assigned U.S. Pat. App. Pub. No. 2007/0055597, and entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. patent application Ser. No. 12/191,796, filed Aug. 14, 2008, assigned U.S. Pat. App. Pub. No. 2009/0048884, and entitled “Merchant Benchmarking Tool,” U.S. patent application Ser. No. 12/940,562, filed Nov. 5, 2010, and U.S. patent application Ser. No. 12/940,664, filed Nov. 5, 2010, the disclosures of which applications are hereby incorporated herein by reference.

### Transaction Terminal

FIG. 5 illustrates a transaction terminal according to one embodiment. The transaction terminal (105) illustrated in FIG. 5 can be used in various systems discussed in connection with other figures of the present disclosure. In FIG. 5, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 5. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 5. For example, in one embodiment, the transaction terminal (105) is an ATM machine, which includes components to dispense cash under certain conditions.

### Account Identification Device

FIG. 6 illustrates an account identifying device according to one embodiment. In FIG. 6, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 6, such as a cellular communications subsystem.

In one embodiment, the communication device (159) may access the account information (142) stored on the memory (167) without going through the processor (151).

In one embodiment, the account identification device (141) has fewer components than those illustrated in FIG. 6. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 7, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the components of systems illustrated in various figures, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the components such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a computer system, such as a data processing system (170) illustrated in FIG. 7. Some of the components may share hardware or be combined on a computer system. In one embodiment, a network of computers can be used to implement one or more of the components.

Further, the data illustrated in the figures, such as transaction data (109), account data (111), transaction profiles (127), and advertisement data (135), can be stored in storage devices of one or more computers accessible to the corresponding components. For example, the transaction data (109) can be stored in the data warehouse (149) that can be implemented as a data processing system illustrated in FIG. 7, with more or fewer components.

In one embodiment, the transaction handler (103) is a payment processing system, or a payment card processor, such as a card processor for credit cards, debit cards, etc.

FIG. 7 illustrates a data processing system according to one embodiment. While FIG. 7 illustrates various components of a computer system, it is not intended to represent any particular architecture or manner of interconnecting the components. One embodiment may use other systems that have fewer or more components than those shown in FIG. 7.

In FIG. 7, the data processing system (170) includes an inter-connect (171) (e.g., bus and system core logic), which interconnects a microprocessor(s) (173) and memory (167). The microprocessor (173) is coupled to cache memory (179) in the example of FIG. 7.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A computing system having at least one microprocessor and memory storing instructions configured to instruct the at least one microprocessor to perform operations, the computing system comprising:
a payment processor configured to process payment transactions in a payment processing network and generate transaction data recording the payment transactions processed by the payment processor;
a portal configured to receive non-transaction data separate from payment processing in the payment processing network, the non-transaction data generated from anonymously tracking of user activities;
a data warehouse coupled with the portal and the payment processor to store:
the transaction data generated by the payment processor, and
the non-transaction data received by the portal;
wherein the data warehouse is configured to
store offline user data in association with offline identifiers of a user,
link offline payment transactions to the offline identifiers of the user, the offline payment transactions made by using an account identifier of the user at offline retail locations of merchants,
link online payment transactions to online identifiers of online devices used by the user, the online payment transactions made by using the account identifier of the user in e-commerce environments, the online identifiers configured to anonymously track user online activities, and
store online user data in association with the online identifiers of the users;
wherein the non-transaction data includes locations determined by a global positioning system receiver of the user; and the computing system is configured to identify association between a payment transaction of the user and an identifier of the user not used in the payment transaction, by matching a location determined by the global positioning system receiver of the user with a location determined by a global position system receiver of a merchant.

2. The computing system of claim 1, wherein the location of the merchant is determined by a global position system receiver of the merchant.

3. The computing system of claim 1, further configured via the instructions to match transactions with identifiers of the user based on transaction locations in the transaction data and user activity locations in the non-transaction data.

4. The computing system of claim 1, wherein the transaction locations and the user activity locations are one of:
online locations; and
offline locations in retail stores of merchants.

5. The computing system of claim 1, further configured via the instructions to perform data matching to link the online identifiers to the online payment transactions.

6. The computing system of claim 5, wherein the data matching is based on device identifiers.

7. The computing system of claim 6, wherein the online identifiers are browser cookies; and the device identifiers includes at least one of:
mobile phone number;
internet protocol address;
media access control address; and
mobile station international subscriber directory number.

8. The computing system of claim 1, further configured via the instructions to perform data matching to link the offline identifiers to the offline payment transactions.

9. The computing system of claim 8, wherein the data matching to link the offline identifiers to the offline payment transactions is based on offline locations and time periods of the offline locations.

10. The computing system of claim 9, wherein the offline locations are determined by global positioning system receivers.

11. The computing system of claim 1, wherein the portal is configured to receive a request identifying a first identifier; and the computing system is further configured via the instructions to determine that the first identifier is in association with the account identifier of the user in the data warehouse, generate an anonymized profile of the user based on the offline user data, the online user data, the offline payment transactions and the online payment transactions, and provide the anonymized profile of the user as a response to the request.

12. The computing system of claim 1, wherein the payment processor is one of:
an issuer processor in the payment processing network;
an acquirer processor in the payment processing network; and
a transaction handler interconnecting issuer processors and acquirer processors in the payment processing network.

13. A computer implemented method, comprising:
processing, by a payment processor, payment transactions in a payment processing network;
generating, by the payment processor, transaction data recording the payment transactions processed by the payment processor;
receiving, in a portal, non-transaction data separate from payment processing in the payment processing network, the non-transaction data generated from anonymously tracking of user activities;
storing, in a data warehouse coupled with the portal and the payment processor, the transaction data generated by the payment processor and the non-transaction data received by the portal;
storing, in the data warehouse, offline user data in association with offline identifiers of a user;
linking, in the data warehouse, offline payment transactions to the offline identifiers of the user, the offline payment transactions made by using an account identifier of the user at offline retail locations of merchants;
linking, in the data warehouse, online payment transactions to online identifiers of online devices used by the user, the online payment transactions made by using the account identifier of the user in e-commerce environments, the online identifiers configured to anonymously track user online activities; and
storing, in the data warehouse, online user data in association with the online identifiers of the user.

14. The method of claim 13, wherein the non-transaction data includes locations determined by a global positioning system receiver of the user; and the method further comprises:
matching a location determined by the global positioning system receiver of the user with a location determined by a global position system receiver of a merchant to associate an identifier of the user with a transaction of the user.

15. The method of claim 13, further comprising:
matching transactions with identifiers of the user based on transaction locations in the transaction data and user activity locations in the non-transaction data.

16. The method of claim 13, wherein the transaction locations and the user activity locations are one of:
online locations; and
offline locations in retail stores of merchants.

17. The method of claim 13, further comprising:
performing data matching to link the online identifiers to the online payment transactions based on device identifiers;
wherein the online identifiers are browser cookies.

18. The method of claim 13, further comprising:
performing data matching to link the offline identifiers to the offline payment transactions based on offline locations and time periods of the offline locations.

19. The method of claim 13, further comprising:
receiving a request identifying a first identifier;
determining that the first identifier is in association with the account identifier of the user in the data warehouse;
generating an anonymized profile of the user based on the offline user data, the online user data, the offline payment transactions and the online payment transaction; and
providing the anonymized profile of the user as a response to the request.

20. A non-transitory computer storage medium storing instructions configured to instruct a computing apparatus having at least one microprocessor to:
process, by a payment processor, payment transactions in a payment processing network;
generate, by the payment processor, transaction data recording the payment transactions processed by the payment processor;
receive, in a portal, non-transaction data separate from payment processing in the payment processing network, the non-transaction data generated from anonymously tracking of user activities;
store, in a data warehouse coupled with the portal and the payment processor, the transaction data generated by the payment processor and the non-transaction data received by the portal;
store, in the data warehouse, offline user data in association with offline identifiers of a user;
link, in the data warehouse, offline payment transactions to the offline identifiers of the user, the offline payment transactions made by using an account identifier of the user at offline retail locations of merchants;
link, in the data warehouse, online payment transactions to online identifiers of online devices used by the user, the online payment transactions made by using the account identifier of the user in e-commerce environments, the online identifiers configured to anonymously track user online activities; and
store, in the data warehouse, online user data in association with the online identifiers of the user.
